(19) United States
(12) Patent Application Publication
(10) Pub. No.: US 2004/0215542 A1
(43) Pub. Date: Oct. 28, 2004

(54) Methods and systems for paying for referrals

(76) Inventor: Michael T. Rossides, Scottsdale, AZ (US)

Correspondence Address: MICHAEL T. ROSSIDES, 11167 E. MIRASOL CIRCLE, SCOTTSDALE, AZ, 85255, US

(21) Appl. No.: 10/822,249

(22) Filed: Apr. 8, 2004

Related U.S. Application Data
(63) Continuation-in-part of application No. 10/424,190, filed on Apr. 25, 2003.

(51) Int. Cl. G06F 17/60

(52) U.S. Cl. 705/35

(57) ABSTRACT

Here we disclose a method for enabling a seller to pay micro-commissions to one or more individuals who deliver a sales message to a prospect. For example, a toy manufacturer might offer to pay people who ask a retailer to stock a particular toy. If the retailer buys the toy then a commission is owed to this group of “grassroots” referrers. Each referrer's share of the commission may be very small, a micro-commission.

The method comprises a set of steps executed by a computer database system interacting with users. In simplified form the steps are: (1) a seller enters a referral offer into the system, (2) referrers then enter referral claims that identify a prospect and that represent claims on a potential commission, (3) the expected value (EV) payment process of U.S. Pat. No. 5,269,521 is used to “probabilistically amplify” the commission owed through a fair bet, (4) if a claim “wins” the EV payment bet process, the amplified commission is calculated and an inspector verifies the winning claim, (5) then, if the claim is found valid, the referrer who submitted the claim is paid his share of the amplified commission.

In addition, the method can be modified to enable a buyer to submit a claim that a referral has been made by an individual leading to a sale.

In addition, the method can be modified enable a buyer to submit a claim that a referral has been made via a medium leading to a sale to the buyer. The method is further modified to enable the medium's owners to be paid, and to enable an individual making a referral in a medium to be paid for that referral.

### CROSS REFERENCES TO RELATED APPLICATIONS

This application is a continuation-in-part of application Ser. No. 10/424,190, filed on Apr. 25, 2003, and titled Method and System for Paying Small Commissions to a Group.

This specification was preceded by disclosure documents 472,757, filed Apr. 17, 2000 and 497,288, filed Jul. 25, 2001. This specification refers to U.S. Pat. No. 5,269,521 concerning the expected value payment method.

This application also overlaps part of, and incorporates by reference, a recent US patent application, filed on Mar. 2, 2004, that does not yet have a serial number, entitled Method and Apparatus for Registering and Amplifying a Payment claim.

This application also includes, as Book III, a recent US patent application, filed on Mar. 29, 2004, that does not yet have a serial number, entitled Methods for Transferring Payment in EV Payment and Verification Systems.

This application also incorporates by reference, U.S. patent application Ser. No. 10/700,836, filed on Nov. 3, 2003, entitled Method and System for Paying Decision Makers for Attention.

### STATEMENT REGARDING FEERALLY SPONSORED RESEARCH

Not applicable.

### BACKGROUND

1. Field of the Invention

This invention relates to methods and systems for paying commissions, referral fees.

2. Description of Related Art

A sales referral or referral is a broad term that means a recommendation or mention, made by a person or medium, leading to a sale.

Paid referrals, in which sellers pay for referrals, are common and go by many names, such as, commissions, finder's fees, referral fees, spiffs, and affiliate fees.

U.S. Pat. No. 5,537,314 (Kanter) describes a “Referral recognition system for an incentive award program” that enables multiple companies to use a single referral payment system for accumulating and paying referral fees. Kanter describes a system for making it easy for a company to offer an incentive program. Kanter does not describe a system for paying multiple people for contacting the same prospect with a sales message.

A recent innovation in the area of paying for referrals is called “automated affiliate marketing” in which a referrer puts an “affiliate link” on a website that leads to a seller's website. If an Internet user clicks on the link and buys from the seller's website, the referrer gets credited with an affiliate fee. This method is described in U.S. Pat. No. 6,029,141. A related patent, U.S. Pat. No. 5,991,740, describes a network for managing affiliates.

The inventive method is different from these and other referral payment methods because its object is different: to enable a seller to pay micro-commissions to a group of referrers who contact the same prospect. No methods or tools developed to date fully enable micro-commissions to be efficiently paid to a group of referrers. Previous technologies have relied on paying an individual referrer for a sale or paying a pyramid of recruits in a multi-level marketing program. Further, existing methods accumulate definite payments, while the invention disclosed employs probabilistic payment.

The invention also provides an efficient way to pay for word-of-mouth recommendations. Existing methods allow sellers to pay for word-of-mouth recommendations, but inefficiently. For example, Joe can tell Mary to use Sprint as her phone company. Sprint can offer to pay Joe for this recommendation. Yet efficiency is lost because Sprint must identify Joe and identify Mary and verify that Joe has made the recommendation to Mary. To make matters worse, the referral fees offered are often too low to justify registering all this data, verifying the referral and transferring payment. Thus, transaction costs and low referral fees often make it impractical for sellers to pay for referrals.

The invention disclosed in the parent application provides novel methods that lower the expected cost of transacting a referral payment. The invention of the parent makes micropayments feasible for word of mouth recommendations.

The invention of the parent application focuses on payments to a group of referrers. As discussed on page 34 of the parent, a group can contain a single referrer. In practice, a method and system for transacting referral payments may be more successful if it enables payment to more than one referrer, given that there will be many cases where a prospect/buyer has received the same recommendation from more than one referrer.

This CIP application adds matter to the parent in being more explicit about describing a certain kind of multi-seller, directory system for enabling sellers to enter referral payment offers, and for enabling referrers and/or buyers to find a referral offer, select the offer and submit a referral claim. Whether this matter is “new matter” is a subjective point that the inventor cannot judge definitively. Many of the methods described in this additional matter seem, depending on point of view, implicit in the parent application.

This application does supply a better description of a particular directory method for enabling referrers to register claims for referral payment. The method enables a referrer and/or buyer to find an offer and select it and then submit a corresponding referral claim.

In the parent, more ways of submitting/registering a claim were disclosed.

The parent did not describe methods for enabling buyers to submit referral claims on behalf of referrers and on behalf of the buyers themselves. This application does disclose new matter methods for enabling buyers to submit referral claims.

This application also discloses methods for enabling buyers to participate in referral payments.

This application also discloses methods for enabling buyers to state that referrals made in the media have led to a sale. These methods thus enable media to be paid for referrals, and enable people making referrals in the media to be paid for those referrals.

### OBJECT OF THE INVENTION

The object of the invention is to enable a seller to pay a referral fee for any kind of recommendation or mention that has been made in any way, by any number of referrers, that helps lead to a sale.

### BRIEF SUMMARY OF THE INVENTION

Here we disclose a method for enabling a seller to pay micro-commissions to one or more individuals who deliver a sales message to a prospect. For example, a toy manufacturer might offer to pay people who ask a retailer to stock a particular toy. If the retailer buys the toy then a commission is owed to this group of “grassroots” referrers. Each referrer's share of the commission may be very small, a micro-commission.

The main obstacle to paying a micro-commission is the cost of verifying that a sales message has been delivered by an individual. A second obstacle is the cost of transferring a micropayment efficiently. The inventive method overcomes these obstacles by paying referrers with a fair chance to win all or part of an amplified commission.

The method comprises a set of steps executed by a computer database system interacting with users. In simplified form the steps are: (1) a seller enters a referral offer into the system, (2) referrers then enter referral claims that identify a prospect and that represent claims on a potential commission, (3) the expected value (EV) payment process of U.S. Pat. No. 5,269,521 is used to “probabilistically amplify” the commission owed through a fair bet, (4) if a claim “wins” the EV payment bet process, the amplified commission is calculated and an inspector verifies the winning claim, (5) then, if the claim is found valid, the referrer who submitted the claim is paid his share of the amplified commission.

In addition, the method can be modified to enable a buyer to submit a claim that a referral has been made by an individual leading to a sale.

In addition, the method can be modified enable a buyer to submit a claim that a referral has been made via a medium leading to a sale to the buyer. The method is further modified to enable the medium's owners to be paid, and to enable an individual making a referral in a medium to be paid for that referral.

### BRIEF DESCRIPTION OF THE DRAWINGS

FIG. 1 is a flowchart showing an embodiment of the inventive method in which the first random selection step occurs before a sale is registered.

FIG. 2 shows a representative form for entering a referral claim into a database system.

FIG. 3 is a flowchart showing an embodiment of the inventive method in which the first random selection step occurs after a sale is registered.

FIG. 4 shows the end result of a process for producing payoff estimate statistics.

FIG. 5 is a flowchart showing the inventive method incorporated into a directory system, creating a payment feedback loop.

### DETAILED DESCRIPTION OF THE INVENTION

### Contents

How this Specification Is Written

Initial Definitions

Book I

Core Modules Comprising the Searchable Directory Embodiment of the Invention

Book II

Preface: How Book II Is Written

Part 1: The Method Using Random Selection Before Registering a Sale

Part 2: The Method Using Random Selection After Registering a Sale

Part 3: Steps for Processing Multiple Referral Fee Offers

Part 4: Using Auditing to Prevent Cheating and Reduce Costs

Part 5: Providing Payment Estimate Statistics to Users

Part 6: Employing the Method to Populate a Commercial Directory

Book III

Methods for Transferring Payment in EV Payment and Verification Systems

How this Specification Is Written

This specification is organized as a set of descriptions of modules (sub-processes) for operating an online computer database. These modules together comprise the inventive method. The modules are high-level descriptions that we use for clarity. The modules themselves can be decomposed into smaller sets of steps, and rearranged, as is apparent to those skilled in technical writing or programming.

The modules may be performed on a single, “central” database system, or they may be performed by “separate” computing database entities that communicate with each other.

The goal of this specification is to disclose the novel aspects of the inventive method and system. There is no ideal way to present these aspects, and so, those skilled in technical writing or programming will see better ways to organize and present this disclosure.

Example cases are provided. Those skilled in the art will know that these examples are illustrative only and do not limit the range of applications of the present invention.

Many of the options described in this specification, such as the terms of EV payment bets, may be held standard in practice. Those skilled in the art will readily see where a user option may be converted into a default.

This specification is divided into three “Books” to cleanly separate the new disclosure from the parent, although Book I mostly repeats or rephrases material in Book II.

Book I of this specification describes a searchable directory embodiment in which sellers store referral payment offers in a database that is searchable by referrers and/or buyers who can then find and select referral offers, and submit corresponding referral claims.

New disclosures in Book I can apply—can add to or modify—the methods of Book II, as will be apparent to those skilled in the art.

Book II is the parent application, which describes broader embodiments with additional front-end interfaces for registering referral claims. Book II also describes methods for paying multiple referrers for making recommendations to the same prospect. Book II does not describe how buyers can submit/register referral claims, while Book I does.

Book III is a copy a recent patent application, Methods for Transferring Payment in EV Payment and Verification Systems, filed by the author, and referenced above. This application is included in this application for the sake of completeness, and because the author is not sure of the patent law—i.e., not sure whether he should include it or not.

We note that a separate patent application was filed on Mar. 2, 2004 that discloses a general method for registering payment claims. This method can be used in conjunction with the invention of this specification.

Initial Definitions

Seller. A person or organization (or agent) that makes a referral payment offer. Seller is a broad, economics term that encompasses any person or entity selling/leasing/loaning a product or service of any kind, or soliciting for money or commodities.

Buyer. A broad, economics term that encompasses any person or entity who buys/rents/borrow/donates—i.e., who is on one end of an economic transaction.

Prospect. A person or organization that might become a buyer.

Product. A broad, economics term that encompasses any product or service or, in the case of referral, a business/org, because a buyer may be referred to a business/org.

Sale. Any kind of sale or purchase (any expenditure of money for some product). Sale is a broad, economics term encompassing one-time purchases, leases, loans, donations, and so forth—virtually any kind of economic transaction.

Referral. Any mention or recommendation of a product or service (or business) that helps lead to a sale. A wide variety of different kinds of referrals can be defined.

Referrer. A person or medium that makes a referral that a prospect is exposed to. A referrer who is a person will sometimes be called by the name Ray.

Referral Payment (RP). A commission offered by a seller to a referrer who meets specified conditions. The amount can be static or a percentage of a sale amount (which can be capped).

Methodfor Paying for Referrals (MPR). One name for the inventive method (another name is used in Book II). Also called, the inventive method or the method.

System for Paying for Referrals (SPR). One name for an online system that operates according to the inventive method (another name is used in Book II). Also called the inventive system or the system.

System Administrator (Operator). A person authorized to operate the inventive system and/or authorized to access all the data stored in the system. Also referred to as Sis.

### Book I: Core Modules of the Searchable Directory Method Embodiment

Intro: The Searchable Directory Method Embodiment

A. Module for Enabling a Seller to Establish an Account, Including Bank Account

B. Module for Enabling a Seller to Enter a Referral Payment Offer

C. Enabling Users to Find a Referral Payment Offer

D. Enabling a Submitter (Referrer or Buyer) to Establish an Account

E. Enabling a User to Select a Referral Fee Offer and Submit a Payment Claim -Buyer as submitter, -Referrer as submitter

F. Executing Payment Bet in which EV Equals Referral Payment, Storing Result

G. Informing a Submitter that His claim Has Provisionally Won

H. Enabling a Submitter to Submit a claim for a Payoff -Buyer as claimant, -Referrer as claimant

I. Enabling an Inspector to Verify that the Referral Meets the Offer Conditions

J. Enabling an Inspector to Find And Flag Duplicate claims and Other Cheats

K. Enabling a Winning, Valid claim to Be Paid Off

L. Module for Reporting Feedback to a Seller

Introduction: The Searchable Directory Method Embodiment

The embodiment of the invention to be described in Book I is a method for operating an online database that is a directory system designed to be searched by users submitting referral claims. According to the inventive method, sellers enter referral payment offers. A user would query the directory to see if a given referral offer existed, and if the offer existed, the user would be able to select and accept the offer, thereby submitting/entering a referral claim.

For example, assume that a manager for Pemi Summer Camp enters a referral payment offer into the system. And assume Ray has recommended Pemi to a friend. Then, Ray could query the directory system using the term “Pemi” and find the corresponding referral offer. The system would enable Ray to submit a referral claim, which might then be paid off, if Ray's friend sends a child to Pemi Summer Camp.

### Section A. Module for Enabling a Seller to Establish an Account, Bank Account

The invention includes a module for enabling a seller to establish an account including a bank account, which can be a debit and/or credit account.

This module is well known and needs no elaboration.

### Section B. Module for Enabling a Seller to Enter a Targeted Discount Offer

The inventive method includes a module for enabling a seller to enter a referral payment (RP) offer into a database system—the SPR—that enables the offer to be transacted. Upon establishing a seller account, the seller will be able to create and store an RP offer. (The inventive system would also include methods for enabling the seller to name the offer and change the offer.)

Certain terms of the offer will dictate key aspects of the processing of the claims—for example, the payoffs of the expected value payment bets that the system executes will be dictated by the terms of the RP offer.

Certain terms of the offer will not affect the processing of claims. But, the terms will be examined by an inspector when he checks whether they have been fulfilled by a referrer—for example, a possible term that does not affect processing, but that needs to be inspected is a term specifying who the referrer must communicate with when making a referral.

All such terms do not have to be entered into a system for executing the SPR; they can be standard, meta-terms that are understood by users.

RP offers are infinitely variable. Below and in Book II we list some of the kinds of terms that such an offer can include. For example, a seller can offer to pay an individual for “telling-a-friend.” For instance, Elite Gym might offer 5% of a sale to people who refer in customers. Elite might offer the same 5% to media that mentions Elite, if a press notice leads to a sale. Elite could offer to pay a media company or an individual reporter or anyone quoted in the company's medium. Elite could basically make an RP offer to virtually anyone or any entity in a position to recommend or mention Elite's service.

As another example, Canon Corporation could pay people or media or journalists who recommend its Powershot cameras to people who become customers.

Any kind of product or service (including any organization) can be recommended. Thus, virtually any type of seller can make an RP offer regarding virtually any product or service.

Accordingly, the invention also provides a method of (or system for) entering into the SPR an RP offer comprised of a set of data that can include any of the following (Book II describes an overlapping set of offer information):

A seller (offerer) name of the person or company (entity) making the RP offer.

A description of the product(s) or the seller that the RP offer applies to (rather than specify a single product, a seller can specify a set of products, or further, can specify all the products that the company sells, in which case the seller may only need to specify the seller's name.

An RP amount that is a constant amount of money or a percentage of a sale amount of the product that the RP offer applies to. The RP amount can be capped. Alternatively, an RP amount can be denominated in units of a product, as when a company offers to pay referrer with the company's product(s), or offers a dollar amount of a product.

The share of the RP that a buyer is eligible to receive, if any, to compensate the buyer for providing, and helping verify information about the referral and for any other work involved in transacting the referral payment.

The location of the referred product or seller

A minimum sale amount (amount of money required to be involved in the sale).

A one-time only condition such that the referrer can only make an eligible referral once to a buyer.

A multiple referrals condition such that a referrer must make a specified number of referrals to different buyers in order to be eligible to be paid.

A new buyer condition such that the RP is only paid if the buyer is buying the specified product or from the specified seller for the first time.

A time period condition such that the sale must take place within the specified period of time.

A decision-maker definition such that a referrer can be paid for a referral to a decision-maker for an organization provided that the decision-maker (person the referrer communicated with in the organization) meets specified conditions.

A deadline for submitting a referral claim. For instance, a referrer might be required to submit a referral claim before, or a certain period of time before, a sale takes place. Or he might be required to submit a claim within a certain period of time after a sale takes place.

An expiration date of the RP offer.

Descriptions of different types of referral corresponding to different levels of payment. For instance, a mention, a recommendation and a sales pitch could be defined, and each type of referral could be assigned a different level of payment.

Additional, non-standard conditions defining who is eligible to receive the RP.

Expected value (EV) bet terms that define the EV bet used to pay the RP.

When the RP bet result is to be revealed.

The SPR stores the offer data and timestamps it.

The offer may be identified with additional data, including a name or other ID.

This module will also include steps for enable a seller to change the offer, and for directing the SPR to keep a record of the previously entered offer.

### EXAMPLE

Let us assume that Elite Gym wants to offer an RP of 5%. Elite establishes an account and then enters (some information may be auto-entered):

| | |
|---|---|
| Seller: | Elite Gym |
| Product referral applies to: | Enrollment in Elite Gym |
| RP amount: | 5% of the total amount of a sale |
| Eligible Referrers: | Any referrer, including in media, and |
| | excluding Elite Employees |
| Expiration: | May 10, 2005 |
| Extra Conditions: | Buyer must be a new buyer, |
| | Not an existing customer |
| Bet terms: | A buyer will have a .001 probability of |
| | winning 1,000× the RP amount |
| When bet result is revealed: | 60 days after purchase |

### Section C. Enabling Users to Find a Referral Payment Offer

As discussed, the inventive method can be implemented as directory system for creating, finding and redeeming RP offers. In this case, such a directory would include a module for enabling a user to search for offers by a variety of criteria, using the information entered by a seller in the creation of an RP offer.

A user means a seller, a referrer, a buyer, or a system administrator—anyone who needs to find an offer.

Accordingly, the invention can provide a method of (or system for) enabling a user to find an RP offer using search criteria, such as a product or seller name, offer conditions, offer name, lookup code, and other identifying characteristics.

We emphasize that the SPR can enable advertisers to identify their offers by entering a variety of descriptive data, and we do not mean to limit the possibilities in any way. Virtually any type of database search means can be incorporated into the SPR for finding offers.

The inventive method and system can also include an interactive voice response interface that is equivalent to a visually presented directory.

Embodiment Including Remote Site Button-Link for Finding an RP Offer

The inventive method and system can also include a module for enabling users, particularly users submitting a referral payment claim, to find an RP by “pressing a button” or the equivalent action, in which the button (e.g., a link) is associated, by well-known means, to a particular offer.

This method is useful if a seller wants to present a “referral payment button” to claim submitters on the seller's website or on a website that is separate from the SPR website.

For example, a website for a Elite Gym might show a link labeled with the following message: Thanks for buying. Now, click on this link ifyou and want to tell us who told you about us. You will be paid 0.25% ofyour purchase for telling us. Thank you.

Such a button/link would lead to a referral claim (submission) form.

Likewise, the system might have an interactive voice response front-end that identifies the offer when a user presses a particular button. For example, Press “1” if you want to get paid $1 for referring customers to Elite Gym.

In other words, the invention can include well-known front-ends for identifying an offer that do not require a search to be done by the user.

### Section D. Enabling a Submitter (Referrer or Buyer) to Establish an Account

The inventive method includes a registration process in which a user who submits a referral claim enters “official” identity information and at least one user name.

In order for the inventive system to register a claim, the system needs to identify the submitter. Identification enables the system to inform the submitter that the claim he has submitted has “won.” Further, identification enables the system and a system administrator (Sis) to search for and detect duplicate submissions of a claim.

For example, assume Ray wants to submit a claim stating that he has told a friend that Hansen's Lemonade is delicious. How is the system to know whether Ray is making one submission or ten? And, how is the system to alert Ray if his claim is a winner? Ray must be identified.

The invention includes the registration of two types of identification. An official, hard-to-fake ID is required so that a submitter cannot cheat. And, a user-friendly user ID is needed to make submitting easy.

Need for an Official ID

Official identification information, which we will call an official ID, will mean information that is hard for a person to fake—that is, hard to fake outside a computer database. This concept is well known. Such hard-to-fake data can include any government ID number (such as a driver's license number), address information, banking information, date of birth, and so forth. An official ID that is stored by the sytstem can include biometric ID data, such as a voiceprint.

An official ID is required to deter Ray from creating multiple identities that would enable him to make duplicate submissions under different names.

If Ray's claim is a winner and he attempts to collect the amplified claim amount, then he will have to prove his identity. This identity will have to match the official ID he has entered when registering his identity with the system.

Thus, the invention provides a method of (or system for): registering official identification data for a submitter in a user identification database.

Need for a User-Friendly User ID

The invention should also enable Ray to have a user-friendly, user ID to identify himself to the inventive system, to make it easy for Ray to submit his claim.

Thus, the invention provides a method of (or system for): registering a user ID that:

(a) a submitter uses to interface with the system, especially when submitting a claim

(b) is associated in the user identity database with the submitter's official ID.

A user ID may be registered automatically after the user's account is established as, for example, when a browser “cookie,” or the equivalent is used to identify a user.

A user name and password can be used as well.

We note that in certain cases, it is possible for a submitter's official ID and user ID to be the same, as when certain kinds of biometric data are used to authenticate a user. For example, a submitter's voiceprint could be his official ID and his user ID.

The Need for Storing a Submitter's Contact Data

The system will also need to register a submitter's contact data in order to inform him when a claim he has submitted is a winner.

Thus, the invention also provides a method of (or system for) registering contact information for informing a user when a claim he has submitted in a winner.

A submitter's contact data can be different from the submitter's user name. Or, the contact data can be the same, as when an email address or phone number is a user name.

Searchable User Identity Database

The user identity database will include means for searching by official ID and user ID, and for finding all the user names that are associated with an official ID. Thus, a system administrator (Sis) can find all of the user names associated with Ray's official ID.

For example, assume social security numbers are used as an official ID. And assume email addresses and phone numbers are user ID's. Then, by searching using Ray's social security address, Sis can find the email address and phone number that Ray has used when submitting claims. Conversely, she could search by one of Ray's user names to find Ray's social security number, and then search by the social security number to find Ray's other user names, if any exist.

Now, a user ID will be part of every claim. And, the claims database (see Section J) will also include means for searching claims by user ID. For example, assume that Ray's user ID is 202-333-3333, and another user ID is ray@mail.com. Then, Sis could search for his claims using his phone number and his email address. She will then find all the claims he submitted under these user ID's.

The phone number and email address would also be associated with Ray's official ID, so Sis could find all of the claims that are associated with Ray's official ID, which is the key to stopping duplicate claim submissions.

Note: Payoff Preference Can Be Registered Too

We note that as part of the user registration process, the invention can provide for enabling a submitter to enter his preferred payoff multiple, such that EV payment bets for the submitter's claims are decided with a random number generation for 1-N, where N is set by the user.

### Section E. Enabling User to Select a Referral Offer and Submit Payment claim

As described in Section C above, the invention will provide a module for enabling a user to find an offer via a search form or via a link associated with the offer.

It will also include a module for selecting an offer and submitting a corresponding claim. (In certain implementations, finding an offer may also signify selecting the offer.)

Accordingly, the invention provides a method of (or system for):

finding an RP offer,

selecting the offer and,

opening a claim form for submitting a claim that corresponds to the offer.

The form can be a webform, a voice form, or any other kind of equivalent form.

The form will include fields for enabling a user to enter the key facts of a referral claim.

The inventive method and system will provide for storing the information entered into a claim form as a claim record, which we will usually call simply a claim.

A referral claim may differ somewhat depending on whether the submitter is a buyer or a referrer. Below, we describe the claim and claim form for a buyer, and then for a referrer.

Buyer as claim Submitter

The module can be configured to enable a buyer to submit a claim for a referrer.

Why would a buyer submit such a claim? One reason is that the referrer might not be able to, as when the referrer is a medium that makes a referral without knowing who has received the referral (for instance, a magazine review of a product). A second reason is that a seller could offer a buyer a share of the referral fee. A third reason is that the referrer could offer a buyer a share of the referral fee.

If the submitter is a buyer, a claim can include the following information, some or most of which can be entered automatically, depending on the situation and implementation:

the submitter's user ID and name (the system may automatically append this information to the claim if the user has logged on—identified himself already)

the RP offer ID (the inventive system will automatically add this information to the claim because the submitter will have selected a particular offer, already identified by the inventive system)

the name of the product bought or the business/org bought from; the system may automatically add this information to the claim when the submitter selects the RP offer because the particular product may be specified by the RP offer—hence, if this is the case, the method and system can include the step of automatically appending the name of the product of the RP offer to a claim

the referrer's name.

The system stores this information as a referral claim and timestamps the submission.

The claim form can also include fields for describing how the referral was made, by word of mouth or in the media, or in a demonstration, or in a speech of some sort. The possibilities are various since people hear about products and businesses in various ways.

If the submitter is a buyer who heard about a product or business/org from a medium, e.g., an article, then a claim can include the name of a medium, the article/story/broadcast and, the person who wrote or spoke the referral. Thus, the claim form may have fields for stating: that a referral was made via a medium, the name of the medium, where/how the referral was made in the medium, the person who made the referral in the medium, and the person's role, i.e. writer, journalist, interviewer, correspondent, and so forth.

The claim form can enable the buyer to submit additional claim information including:

whether the buyer is buying for her own behalf or for an organization, and if so, the organization's name and the buyer's title.

the date of the referral

the date (approximate or exact) of the sale

the amount of money spent in the sale.

the fact that submitter is acting in the role of a buyer.

For example, assume that Barry has just rented an apartment from the Alban Towers, which was recommended by his friend Ray. Barry can submit a claim by accessing the system, entering his user ID, stating that he rented an apartment from Alban Towers, and stating that Barry recommended Alban Towers.

A claim form can also include a field for entering the type of referral made (applicable if an RP offer stipulates different payment levels depending on the type of referral made).

Enabling a Submitter to Set the Payoff

Whether a submitter is a buyer or a referrer, a claim form can enable the submitter to enter a desired payoff for the claim, to be used to set the terms of the EV payment bet that is applied to the value of the claim.

This payoff becomes part of the claim record, to be referenced and used when the system executes a payment bet for the claim.

The payoff can be a static, dollar amount, or a payoff multiple.

For example, if an RP offer states that a buyer will be paid 1% of a sale to provide proof-of-purchase, then the buyer may set the payoff multiple at, for instance, 200×(meaning 200% of a sale). As another example, if an RP offer states that a buyer will be paid $3 to provide proof-of-purchase, then the buyer might set the payoff at, for instance, $300.

The capability to set the payoff can be important, especially for a buyer in cases where the buyer has to expend effort, to provide proof-of-purchase. (In certain cases, the inventive system can automatically register a sale, including proof of purchase, which means that the buyer has to expend no effort.)

If the buyer has to do work to enable the RP to be transacted, he will usually want to be compensated. Thus, the buyer will want to set the payoff amount higher enough to compensate him for his effort.

A buyer and referrer will often have different EV payments in an RP offer. For example, if a referral payment is $10 EV, the buyer's share might be $1 EV. So, the buyer and the referrer might want different payoffs. But, in cases where the buyer's effort in submitting proof of purchase is essential, the buyer's payoff preference is the key one. That is why, if the submitter is a referrer, the referrer may decide on a payoff that the referrer thinks the buyer will prefer rather than a payoff that the referrer prefers.

Referrer as Claim Submitter

If the submitter is a referrer, a claim can include the following information, some or most of which can be entered automatically, depending on the situation and implementation:

the submitter's user ID and name (the system may automatically append this information to the claim if the user has logged on—identified himself already)

the RP offer ID (the inventive system will automatically add this information to the claim because the submitter will have selected a particular offer, already identified by the inventive system)

the name of product or the business/org recommended or mentioned by the referrer; the system may be automatically add this information to the claim when the submitter selects the RP offer because the particular product may be specified by the RP offer—hence, if this is the case, the method and system can include the step of automatically appending the name of the product of the RP offer to a claim

the buyer's, or potential buyer's, name; and if the buyer is an org, the name and position of the person that the referrer communicated with

the referrer's name (if the referrer is submitting the claim, the user ID can be automatically used to identify the referrer).

A claim form can also include a field for entering the date of the referral.

A claim form can also include a field for entering the type of referral made (applicable if an RP offer stipulates different payment levels depending on the type of referral made).

If a referrer enters a claim before a sale takes place, then the referrer will, obviously, not know the sale amount. If a referrer enters a claim after a sale takes place, then the referrer may know the sale amount. Thus, a claim form, even for a referrer, can include a field for entering a sale amount, if known.

Maintaining a User's claiming History

In order to prevent cheating, it is useful to store all of a user's claim submissions. A user who makes claims at a statistically significant rate above average may be indicating that he is a cheater. Thus, as part of the process for enabling a user to claim an EV RP, the invention can provide a method of (or system for) storing a claim as part of a user's claim history, which can be made accessible to system operators.

Making the Claim Identifiable to Prevent Double-Claiming

A claim should be made identifiable in such a way that duplicate claim submissions can be detected by a machine and/or by a person inspecting of a user's claiming history.

### Section F. Executing Payment Bet in which EV Equals Referral Payment, Storing Result

The invention provides a module for executing an RP bet for each claim that is submitted.

For simplicity, we assume that the EV of the bet is equal to the RP amount, while we realize that the EV bet terms can include an adjustment such that the EV is less than the RP amount in order to accommodate transaction costs and fees.

The RP can be a percentage of a sale. In this case, the payoff in the EV bet will be a multiple of the percentage, with the probability of winning set at 1/multiple. Thus, the payoff is a multiple, N, of the original, yet uncertain, value of the claim.

For example, if the RP for recommending BestSitters is 20% of an initial purchase, and the payoff multiple is 100, then the payoff is 2,000% times the initial purchase. So, assume that Ray has recommended BestSitters to Mary. And assume that she has bought babysitting services costing $24. And assume that Ray has submitted a claim that wins. Then, he is eligible to be paid 2,000%×$24=$480.

It is also possible for the payoff of the EVPM bet to be set as a static dollar (or other currency amount), such as $5, with the probability of a claim winning set at (static amount)/(static payoff). This option is possible when the submitter is a buyer or referrer who has reported the sale amount (that is, when a submitter knows the initial, dollar value of the claim he is submitting).

Upon a winning result for a claim, the bet module triggers another module (see Section G) for informing the submitter that the claim is a winner.

Timing of the Bet Execution and Result Revealing

The timing of the bet execution (random number generation) and of revealing the result of the bet to the submitter will depend on the implementation of the method, and can vary quite a bit given the great variety of products that a referral offer can apply to.

Appending a claim ID to a Winning Claim

In most implementations, the system will include the step of adding a claim ID to a claim, especially to a winning claim, so that the submitter can easily reference the claim. This claim ID is also for other users who need find the claim to verify that it is valid.

For example, if BestSitters offers a referral payment, and if Ray has submitted a claim that is a winner, then BestSitters will want to be able to find the original claim data to verify that Ray has fulfilled all the conditions of the referral payment offer.

Storing the Result of the EVPM Bet

The system will include the step of adding the payoff (a static payoff or payoff multiple) to a winning claim (unless all winning claims have the same payoff/multiple) so that when the claim is retrieved, the payoff is shown with it.

Whether a claim is a winner or loser, the system will provide for storing the result along with the rest of the claim data.

It is important to keep losing claims so that they can be searched by automated means and/or by a system operator to detect whether a user is making duplicate submissions. If the system only stored winning claims then a user could submit multiple claims for the same referral (same payment claim) without having duplicate entries detected.

It is true that this cheat can be detected if a user has two winning claims for the same referral, so it is not strictly necessary to store winning and losing claims. But, it is more likely that the cheat will be detected if winning and losing claims are stored.

Thus, the method can provide for storing winning and losing claims such that they can be searched by any of the claim data entered, and including any additional data generated by the inventive method, such as the bet result.

Two-Bet (“Parlay”) Process

In the inventive method and system, a two-bet process is especially useful in which the EV of the first bet equals the RP, and the EV of the second bet equals the payoff from the first bet.

For example, if BestSitter owes Ray $1 EV, a first bet might have a payoff of $100, with probability of winning set at 1/100. The second bet would then have an EV=$100 and, for instance, a payoff=$500, with a probability of winning=⅕.

As another example, if BestSitter owes Ray 10% of a sale, a first bet might have a payoff multiple=10, with probability of winning set at 1/10. The second bet would then have an EV=100%, and, for instance, a payoff=500%, with a probability of winning=⅕.

Two-bet processes have various advantages, as described in the related patent applications cited above. The application titled Methods for Transferring Payment in EV Payment and Verification Systems, filed Mar. 29, 2004, and incorporated by reference, does the best job of explaining advantages and processes for executing two-bet EV payments.

When an RP is a percentage of a sale, and when the sale amount is unknown by a claim submitter, then a two-bet process is especially useful. After a claim wins the first bet, the inventive method and system can include a step for querying the claimant and asking him whether a sale was made, and if a sale was made, how much the sale amount was for. At this point, the claimant can respond.

If the claimant does not respond, the value of the claim can be set to zero, and the lack of response can be stored as part of the claim record.

If the claimant does respond, and says, “no sale took place,” the value of the claim can be set to zero, and the response can be stored as part of the claim record.

If the claimant does respond, and says, “yes,” and provides the sale amount, this sale amount can be stored as part of the claim record, and can be used to set the bet terms in the second bet.

For example, assume that the RP is 10% and the payoff multiple in the first bet is 20×. And assume that a claim wins. The system then asks Ray if a sale to BestSitters took place. Ray finds out from his friend whether his friend bought, and finds out that an $80 sale did take place. Then, the claim has a provisional value, after this first bet result, of 10%×20×$80=$160.

The inventive system can include steps for enabling the submitter to set the payoff on the second bet (see also, Section E).

A second bet can be executed where the payoff, set by the submitter or by default, is a static amount, such as $500, with the probability of winning set accordingly. Or a second bet can be executed where the payoff is another payoff multiple, such as 10×.

Or, the calculated payoff, $160 in this case, may be enough for the claimant to ask that the claim be subjected to an inspection. Thus, if a two-bet process is used, the inventive system can include steps for enabling a submitter to request that the claim be inspected after a winning result in the first bet.

### Section G. Informing a Submitter that His Claim has Provisionally Won

The invention will provide a module for informing a submitter that his claim has won an EV payment bet.

The submitter can be informed in a variety of ways, including email, or a screen alert on the submitter's system account page.

The alert will provide the submitter with a claim ID or simply with a link that enables the submitter to submit a payoff claim, or other information, such as a sale amount, regarding the claim.

If one payment bet is used, then the submitter will have to submit a payoff claim, which includes submitting proof-of-purchase information, in order for the claim to be paid off.

If a two-bet process is used then, after winning the first bet, a submitter may only have to acknowledge that a sale has taken place and, possibly, provide a sale amount, and other information describing the sale.

Thus, a communication with a submitter about a winning claim can vary depending on the implementation of the invention.

If the Submitter Is a Referrer

If the submitter is a referrer, and if the buyer needs to provide proof-of-purchase, then the referrer will have to contact the buyer and ask the buyer to provide proof-of-purchase.

The inventive system can enable the buyer to provide proof-of-purchase, and use the claim ID to reference the appropriate claim.

If the Submitter is the Buyer and the Referral was by Word of Mouth

If the submitter is the buyer and the referral was by word or mouth, for instance, by a friend or associate, the buyer will need to contact the referrer so that the referrer can then enter his own contact data into the system, so that the referrer can be paid.

(The referrer can informally offer the buyer a share of the payoff. Note that the buyer may be owed money too, if the RP offer gives a share of the payment to the buyer, in exchange for the buyer's help in the transaction.)

If the Submitter is the Buyer and the Referral was Made Via a Medium

If the submitter is the buyer and the referral was made via a medium, the buyer will need to contact the medium so that the medium (or an individual making the referral in the medium) can be paid.

To facilitate this contact, the inventive system can include steps for enabling a medium to establish an account where the medium's representatives can learn about RP payoffs. An alert to such an account can include the buyer's contact information as well, so that the medium can offer the buyer a share of the payoff.

For example, assume that The Wall Street Journal favorably reviews the Flavia Coffeemaker, and that a reader, Mike, buys the Flavia. Assume, further, that the Flavia Company has entered an RP offer in the inventive system, offering $5 to any medium that mentions the Flavia, resulting in a sale. Further, assume that Mike submits a referral claim saying that he heard about the Flavia from The Journal, and that this claim wins an EV payment bet where the payoff is $1,000. Now, Mike must contact The Journal to tell them that the claim has won and that they can collect if he provides proof of purchase. The inventive system can enable him to send an alert to The Journal and provide his contact data to the Journal.

### Section H. Enabling a Submitter to Submit a Claim for a Payoff

The invention provides a module for enabling a submitter to submit a claim for a payoff.

When the system informs the submitter that his claim is a winner, the system will also provide a form, or instructions, to the submitter to enter a payoff claim that provides information that shows that the claimant has met the condition of the RP payment offer.

The payoff claim data will include proof-of-purchase data, including:

Product or service that purchased

Company the purchase was from

Name of purchaser

Amount of the sale (how much was paid or will be paid)

Date of the purchase.

Proof of purchase may be entered electronically, or using paper receipts. Accordingly, the invention can provide a variety of well-known communication channels (including physical mail) for enabling the recipient to make the payoff claim.

If physical receipts are used, then the system will include means for enabling a system operator to log that the paper receipts to correspond to a given payoff claim.

If the submitter is a buyer, then he can submit the proof-of-purchase.

If the submitter is a referrer, he will have to obtain proof-of-purchase from the buyer, or he will have to ask the buyer to submit proof-of-purchase.

Thus the inventive system can include means for enabling a buyer to submit a payoff claim on behalf of a submitter. The system can enable the buyer to find the payoff claim using a claim ID (many kinds of claim identifier are possible).

The system stores the payoff claim and informs an inspector that the payoff claim information needs inspecting.

The system can also include steps for receiving an inspection fee and registering that the fee corresponds to the payoff claim.

Likewise, the system can also include steps for receiving a deposit and registering that the deposit corresponds to the payoff claim (and steps for confiscating the deposit upon an inspection finding that the claim is invalid).

Maintaining a User's Payoff Claiming History

In order to prevent cheating, it is useful to store all of a user's attempts to claim a payoff. A user who makes payoff claims at a statistically significant rate above average may be indicating that he is a cheater. Thus, as part of the process for enabling a user to claim a payoff, the invention can provide a method of (or system for) storing a payoff claim as part of a user's payoffclaim history, which can be a subset of the user's claim history, and which can be made accessible to system operators.

### Section I. Enabling an Inspector to Verify That the Referral Meets the Offer Conditions

The invention will include a module for inspecting a payoff claim to see if the claim is valid, that is, to see if the referral meets the RP offer conditions. When a user has submitted a payoff claim, the system will assign the claim record a status indicating that the claim record is to be examined by a system-authorized inspector. Thus, to enable an inspector to decide whether the winning recipient has met the offer conditions, the invention will provide a module for:

informing a system-authorized inspector that a claim is to be inspected,

enabling the inspector to inspect the claim record and,

viewing the corresponding RP offer.

The inspection will take place outside of the inventive system, and the inspector will enter the result (decision) of the inspection into the system. The inventive system can enable an inspector to explain why he has rejected a claim, i.e., the inspector system can include a standard menu of options explaining why he has rejected the claim, or can enable him to enter a text explanation of his own.

If the inspector approves a claim, the system passes the inspector's decision to a payment transfer process for transferring the payoff to the recipient.

Inspecting a Fraction of the Payoff Claims

We expect that in most implementations of the invention, a claimant would have to put up a deposit, to ensure that his claim was valid. The deposit would be forfeit in the claim were invalid. A twist on this idea, to increase the efficiency of inspection, it is to ask claimants to put up a large deposit, and only inspect a fraction of the claims, with some pre-set selection (e.g., random selection of claims to inspect). The un-inspected claims would be assumed valid.

### Section J. Enabling an Inspector to Find Duplicate claims and Other Cheats

The invention will provide a module for enabling the system to detect duplicate claims. It can also include other modules for detecting other violations/cheats against RP offers and against the inventive method and system. Sellers using the inventive system will want to be assured that these cheats are deterred. Indeed, the modules described in this Section J, along with a database of users' claiming histories, can together comprise a separate, stand-alone invention (database system) for detecting cheating in a probabilistic referral payment method and system. This cheat detection system acts somewhat like an insurance database system that registers and measures a users' claiming history.

The invention will provide a module for enabling an inspector to search a user's claiming history by any information that is part of a claim to detect duplicate submissions. The inventive method and system can also include algorithms for detecting and flagging duplicate claims submitted by a given user. Further, the invention can provide for enabling an inspector to flag and disqualify duplicate claims.

The system can also enable an inspector to put a flag in a submitter's user profile to state that the submitter has submitted a specified number of duplicate claims.

This capability can be important, as a user's record can be used to assign privileges and penalties to the user. A user might be assessed a fine for submitting duplicates. Or, the user might be banned from using the system entirely.

Enforcing a One-Time Referral Condition

An RP offer will often stipulate that a referrer can only be paid once for making a referral to a given prospect. For example, if Ray recommends BestSitters to Kelly, and Kelly buys services from BestSitters, Ray can only claim this referral once. Kelly may buy multiple times from BestSitters, but Ray's first referral claim is the only one that counts.

Ray may want to cheat the system by submitting referral claims each time he mentions BestSitters to Kelly, or if he knows that Kelly is a regular customer of BestSitters.

By providing a method of (or system for) detecting and flagging claims that are duplicates the invention includes the means to prevent this cheat.

Enforcing a First-Time Buyer Condition

An RP offer will often stipulate that a referrer can only be paid for making a referral to a new customer, a first-time buyer.

For example, an RP offer can stipulate that Ray cannot be paid for making a referral about BestSitters to Kelly if Kelly is already a customer of BestSitters.

Yet, if Ray knows that Kelly is already a customer of BestSitters, he may want to cheat by submitting a referral claim that he has told Kelly about BestStitters.

This cheat needs to be prevented mainly in the inspection process, outside of the invention, in which an inspector would have to ask BestSitters whether Kelly was a customer before Ray's referral claim was entered.

But, the invention can include a flagging process for further deterring this cheat such that if an inspector finds that Ray has entered a claim for referring an existing customer, the inspector can enter a flag in Ray's claiming history that Ray has submitted a claim that violates the first-time buyer condition.

Accordingly, the invention can provide a method of (or system for) entering a flag (notation) that a user has violated a first-time buyer condition of an RP offer.

Further, the invention can provide the steps of tallying the violations of a first-time buyer condition and flagging when a user has exceeded a threshold of violations.

Too Many Successful Referrals (Where Claims Are Submitted Before Sales)

One way that cheating by a referrer can be detected is to measure how many referral claim, submitted before a prospect has bought, are successful in the sense of leading to sales. That is, if Ray submits, for instance, 100 referral claims, and his claims win 10 first stage bets (assuming a two-bet process), and all 10 of these claims are for referrals that have led to sales, cheating should be suspected.

The reason that cheating should be suspected is that a referral will “fail” a large percentage of the time because prospective buyers often will not follow the referral.

Thus, the invention can provide a method of (or system for) measuring the success rate of a user's referrals (rate of a referral leading to a sale), and if that rate exceeds a threshold, flagging that excess in a user's claiming history.

A flagged user can be penalized, depending on the implementation of the invention.

Deterring False Referral Claims Made by Users Acting in Cahoots

While two or more people can legitimately submit a claim for a referral about the same product, to the same prospect, it is also possible for users to cheat the method and system by submitting multiple claims in cahoots. For example, assume that Mary knows she is going to buy from BestSitters within the next week. She contacts her friends, Ray, Rick and Randy, and tells them to submit a referral claim stating that each recommended BestSitters to Mary. Then there will be three claims submitted, each with a chance to be amplified.

Alternatively, without Mary's knowledge, Ray can tell his friends, Rick and Randy, to submit claims because he has recommended BestSitters to Mary and he knows that she is about to buy it.

One way to deter these cheats is to detect when a pair of users submits claims for referrals of the same product too many times. That is, if two (or more) users submit a referral claim for the same product more than a threshold number of times, this “outlier” behavior can be detected, and the submitters can be flagged. For instance, if Ray and Rick submit claims for referring the same babysitting company, same pool company, same dentist, same camera, and so forth, then this behavior can be detected and flagged.

Or, if a single submitter has a winning claim in common with any other submitter more than a threshold number of times, that submitter can be flagged as someone who is trying to cheat the system. This cheat means that a referrer or buyer has been switching confederates in order to try to fool the system.

A second way to deter these cheats is to register when duplicate claims are submitted for referrals made to the same buyer. That is, if two or more submitters enter a referral claim for the same product and the same buyer, more than a threshold number of times, this “outlier” behavior can be detected, and the submitters and the buyer can be flagged. For instance, if Ray and Rick submit claims for referring the same babysitting company, same pool company, same dentist, same camera, and so forth, all to the same buyer, Kelly, then this behavior can be detected and flagged.

A third way to deter the cheat of referrers in cahoots, which is outside the inventive method and system, is to ask the buyer who the most important referrer was. The referrer that the buyer says was most important can be the one to claim the payoff. If the buyer does not know that one of the referrers has won, then the cheat is deterred. In other words, if the buyer is not in cahoots with the referrers, this method can deter the cheat.

Module for Deterring Cheating when Referrals are Made to an Organization

Very often, different referrers will, legitimately, make referrals to different people in an organization (org).

And, a single referrer will often legitimately make referrals to different people in an org.

The seller may stipulate that a referral counts only if it was made to a decision maker or “the” decision maker or “the most important” decision maker in the org.

The invention can accommodate multiple, legitimate referrals to the same org, as discussed in Book II, and as disclosed in a U.S. patent application Ser. No. 10/700,836, titled Method and System for Paying Decision Makers for Attention. Division of referral payments can be made in various ways, assuming all referral claims are legitimate

However, cheating is possible when referrals are made to people in an organization.

A key cheat to be deterred is when multiple referrers and or managers submit referral claims for referrals made to different people. The referrer and managers do not know which claims will win. If a claim wins, the winning referrer, and the manager he communicated the referral to in the org, can then say that this manager is the real decision maker, thereby enabling the referrer and manager to claim the payoff. The other managers can be in cahoots, and agree to go along with this assertion when an inspector does and inspection and asks managers who the decision maker was in a sale.

This cheat can potentially be deterred by a thorough inspection.

It can also be deterred in other ways, disclosed in the patent application referenced above.

One way the cheat can be deterred is to match all the referrals claims that are made to the same org, for the same product, and then, if one of the claims is a winner, to not reveal the winning result to the submitter alone.

Instead, the invention can provide steps for alerting all the submitters of the matched claims that one of the claims is a winner, but not telling the submitters which claim won. The system can query these submitters asking them who the real decision maker is, and requiring that only one decision maker be named, or requiring that if multiple decision makers are named, that their payments will be discounted by the number of decision makers involved in the sale (that is, if an RP is, for instance, $100 EV, and 10 decision makers are involved in a sale, then the RP per decision maker would be $10 EV).

Then, upon receiving the responses, the winning claim can be revealed.

If the winning claim corresponds to the real decision maker, or one of the real decision makers, then the payoff can be paid. If the winning claim does not correspond to a decision maker, it can be disqualified.

### Section K. Enabling a Winning, Valid Claim to Be Paid Off

The invention provides a module for paying a payoff for a winning, valid claim.

Once an inspector approves a payoff claim, by entering an approval for the claim into the inventive system, then the system registers that the referrer named in the claim is owed the payoff. The payoff authorization can be sent to a separate entity that actually transfers money to the referrer, or the system itself may include this capability.

Whether the payoff comes from the seller's bank account or the system's bank account, or both, will depend on the particular sub-methods that are used.

Several of these sub-methods are described in the patent applications referenced at the beginning of this patent application. These sub-methods are compiled and described in the application titled Methods for Transferring Payment in EV Payment and Verification Systems, filed Mar. 29, 2004 by the author, and copied into this application as Book III. Book III describes how an EV payment process can be configured to enable:

the seller to take the payoff risk in a one or two-bet process

the system to take the payoff risk in a one or two-bet process

the seller to take all the payoff risk in a first bet, and the system to take the payoff risk in a second, parlay bet

the system uses a discount formula to adjust for invalid claims.

The inventive method and system of this application can include any or all of the processes described in this referenced patent application. We omit them from this application to save space.

Paying Off Buyers

As described above (Section B) a referral offer can include an offer to pay a buyer for taking the trouble to help in reporting and/or validating a referral claim.

The fee may be a share of the referrer's payment, or it can be a separate, distinct fee.

Thus, the inventive method can include additional steps for paying off buyers when a winning referral claim is found valid. These steps include:

check whether the terms of the RP offer provide for paying a fee to the buyer,

if the terms provide for paying a fee to the buyer, multiply the fee by a payoff multiplier that is equal to the payoff multiplier in the referral claim bet (because the buyer's claim actually won the same payment bets as the referrer's claim) where the buyer's claim payoff is proportional to the referrer's claim payoff,

authorize payment of the buyer's payoff to the buyer.

This method applies if there is a two-bet process as well.

The amplified buyer payment may still be too low for certain buyers. Thus, the inventive method can also include the steps of querying a buyer to see whether he wants to be paid the amplified amount, or whether he would like to bet the amplified amount in another bet.

Or the amplified buyer payment may be below a system default amount. Thus, the inventive method can include the steps of executing another payment bet where the buyer is risking his existing payoff to win a larger payoff.

Letting the Referrer Assign a Share of the Payoff to the Buyer

The inventive method and system can also include steps for enabling a referrer to assign a share of a payoff to the buyer. This possibility was noted in Section G, in the case where a medium is the referrer and the medium desires to pay the buyer a share of a payoff in exchange for helping the medium collect the RP payoff.

### L. Module for Reporting Feedback to a Seller

The invention can provide a module for providing reports—feedback—to a seller.

This module can includes steps for calculating and presenting a variety of useful information to a seller including:

The number of claims submitted over a specified period of time

All the losing and winning claims over a specified period of time

The EV amounts paid out for each claim (if the seller had an account in which the EV was deducted per claim, possibly adjusted by a discount factor)

The payoffs paid out over a specified period of time

The percentage of payoff claimed that were also validated

The amount per sale that was entered along with each claim, if an amount was entered

The amount per sale that was entered along with each payoff claim, if an amount was entered

The number of claims made over a specified period of time, for a specified referral payment amount (this statistic can enable a seller to calibrate how much to offer in a referral payment)

A graph showing how claims submitted over a specified period of time vary with the referral payment amount.

Enabling a Seller to Communicate with Claim Submitters

As important additional feedback, the inventive system can enable a seller to communicate with submitters to ask questions with answers that can help a seller calibrate RP offers.

Such questions to buyers can include:

Would you have bought without the referral?

Such questions to referrer can include:

Would you have made the referral without a referral payment?

What is the minimum we could have paid you to make the referral?

### Book II

### Method and System for Paying Small Commissions to a Group Contents of Book II

Preface: How the Specification of Book II Is Written

(Note: “Parts” below refer to Parts of this Book II)

Part 1: The Method Using Random Selection Before Registering a Sale

Part 2: The Method Using Random Selection After Registering a Sale

Part 3: Steps for Processing Multiple Referral Fee Offers

Part 4: Using Auditing to Prevent Cheating and Reduce Costs

Part 5: Providing Payment Estimate Statistics to Users

Part 6: Employing the Method to Populate a Commercial Directory

### Preface: How the Specification of Book II is Written

Referring to the Invention of Book II: Method for Paying Small Commissions (MPSC)

The full name of the invention is Method and System for Paying Small Commissions to a Group. We will abbreviate it to Methodfor Paying Small Commissions (MPSC).

(Less formally, but perhaps more descriptively, we can call the invention a Grassroots Referral Payment Method because the object is to enable a seller to reward a group of “grassroots” supporters who recommend the seller's product, service or company.)

For brevity's sake, we often refer to the MPSC anthropomorphically saying “the MPSC does so and so.” We rely on the reader to infer the meaning from the context—e.g., we might mean, “the computer system performing the MPSC does so-and-so.”

For simplicity's sake, we usually refer to the invention in the singular, although multiple embodiments are disclosed in this specification.

In this Book II, the invention and the inventive method will refer to the inventive methods described in this Book II. Likewise, the invention and the inventive system will refer to the inventive systems described in this Book II.

Two Basic Embodiments of the Method

We will describe two basic embodiments of the method and then describe enhancements. Part 1 describes the first basic embodiment and Part 2 describes the second.

In Book II, First Embodiment Means The First Embodiment of Book II

Note: In this Book II, when we say first embodiment, we mean the first basic embodiment of Book II, as described in Part 1 of Book II.

Definitions in Part 1 Apply to Part 2

We supply definitions in Part 1, which we also use in Part 2.

Variations Possible

While we supply sequences of steps, we do not restrict the invention to a particular, precise sequence, but realize instead that the steps themselves are paramount. Those skilled in the art will easily see where the sequence can be changed without altering the basic method itself. Likewise, we recognize that minor variations in the steps themselves can be made without altering the essential, inventive method.

Describing What is Novel

We strive to only describe what is novel, omitting obvious details.

### Part 1: The Method Using First Random Selection Before Registering a Sale

Object of the Invention of Book II

The inventive method enables a seller to offer multiple people a small sales commission for delivering a sales message to the same prospect. For example, a cable channel might want a local cable company to carry its channel and might offer people a commission for asking the cable company to carry the channel.

Illustrative Example of a Seller: A Commercial Directory called the Y-Pages

Throughout this specification, as our example of a seller, we will use the management of a hypothetical, online directory, which we will call the Y-Pages. We will assume that the management wants to pay people to ask advertisers to buy listings in the directory.

Initially we will consider the simplest case in which the seller makes an offer regarding just one advertising prospect, Sears. In other words, we will assume that the Y-Pages makes an offer to the public that whoever asks Sears to become listed on the Y-pages gets to split a commission if Sears indeed buys a listing in the Y-Pages.

Three Types of Users of the System

MPSC is performed by a database system interacting with three types of users:

Sellers. A seller provides the terms of a referral payment offer. (A seller may be an individual or entity that sells or leases anything, or an agent for such an individual/entity. We note that, equivalently, a system operator may enter the terms provided by a seller into the database system.)

Referrers. A referrer submits a claim, which is then processed by the system.

Inspectors. An inspector decides whether a provisionally winning claim has met the conditions of the referral offer and then enters the decision into the system.

Name for a Referrer

For brevity's sake, we will sometimes call a referrer by the name Ray.

The Key to Labor Savings Is the Use of Expected Payments

The key labor saving technique of the MPSC is the use of the Expected Value Payment Method (EVPM) in the processing of referral claims. This means that referrers are paid with a chance to win a payoff that equals their commission amplified by a certain factor. This factor depends upon the probability set in an EVPM bet. In other words, referrers are paid in expected (in the mathematical sense of the term) payments, not definite payments.

Definition of an EV Payment Bet

In the EVPM, a payer offers a payee a bet in which the expected value (EV) for the payee is equal to the amount that the payer owes the payee.

The payoff on such a bet is greater than the amount owed. The chances are set so the EV=the amount owed. And a random number selection is performed to determine if the payee has won and receives a payoff or has lost and receives nothing.

The payoff can be set as a specified amount of money, e.g. $500. If so, then the chances of a payee winning are set at: (amount owed)/(static payoff).

Or, the payoff can be set as a multiple or the amount owed, e.g., 1000×. If so, then the chances of a payee winning are set at 1/multiple. Using a multiple is especially useful where the exact amount of the commission owed is yet to be determined.

In the MPSC, referrers submit referral claims, which represent claims on a potential commission.

We say that these claims are “exposed to” an EV payment bet when a random selection is executed to determine whether the claims are worth nothing or a payoff—either a static amount or a multiple of the amount of the claim.

(We note that payoffs and the probability of winning can be adjusted to accommodate profit margins for system operators, but that is a minor variation on the EVPM.)

Meaning of $1 EV

When we say that a person is paid with $1 EV, we mean the person is paid an expected dollar, in the mathematical sense, a dollar paid through the EVPM.

Meaning of “Sale” and “Commission”

In this specification the term sale is a broad economics term that encompasses virtually any kind of economic transaction—any kind of sale or lease commitment or service contract—any kind of sale or lease whether a one-time sale or lease or a commitment for a series of purchases or leases or loans or donations. As is well known, there is no single method for how and when the revenues—and the total commission owed—from a sale/lease/loan are calculated/recognized. The particulars of revenue recognition and commission calculation will vary depending on the situation. The inventive method can accommodate any scheme that is employed.

The Method Using Random Selection Before a Sale is Registered

In the first basic embodiment, referral claims are subject to a random, EV payment selection step before a sale is registered. This embodiment is especially suited to applications in which a sale has to be found and reported by human labor, rather than automatically.

What do we mean by that? Consider a situation that the invention addresses. Assume that the Y-Pages wants people to call Sears. Now assume that Ray calls Sears and recommends the Y-Pages to a marketing manager.

Now, Ray is only eligible to be paid money if a sale is made, so the sale event has to be registered somehow. In some situations, a sale can be registered automatically; in others, a person has to find out about the sale and report it to the system executing the MPSC.

If a person has to find out if a sale has been made and then report that sale, it is best to do that only when the stakes are adequately high. Thus, in the first embodiment, the method probabilistically amplifies the value of a referrer's claim. Then, it is cost-effective for a person check and report whether a sale has been made.

(We note that this embodiment can also be used in situations where a sale is registered automatically by a system that executes the MPSC.)

Steps of the Inventive Method, First Embodiment

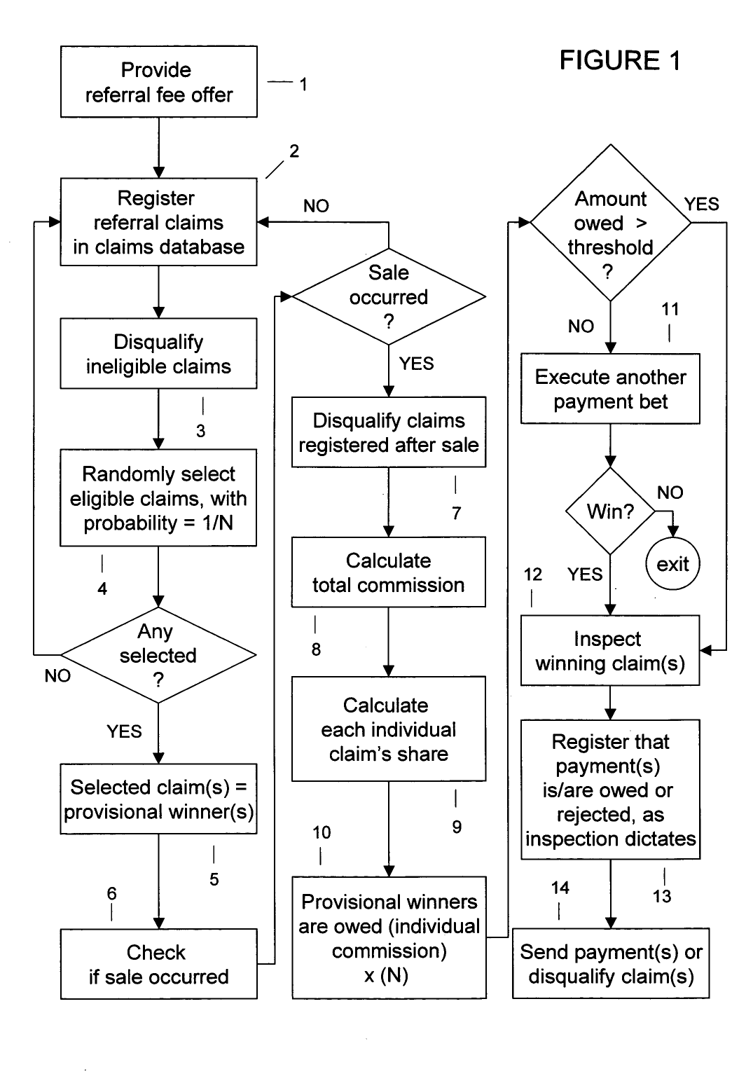

As shown in FIG. 1, the first basic embodiment of the MPSC comprises the following steps, which we list briefly, and then describe in detail:

1. Provide (1) referral fee offer.

2. Register (2) referral claims in a claims database.

3. Disqualify (3) ineligible claims.

4. Randomly select (4) eligible claims with each claim having a 1/N chance of selection.

5. If any are selected, they are designated provisional winners (5).

6. Periodically check (6) if a sale has occurred.

7. If no sale has occurred, continue registering claims. If a sale has occurred, register it and disqualify (7) claims registered after the time period allowed for referral claims has expired, and then go to step of calculating the total commission.

8. Calculate (8) total commission.

9. Calculate (9) each individual claim's share of the total commission.

10. Provisional winners are provisionally owed (10) (their individual commission's)×(N).

11. If the amount provisionally owed is above a threshold, go to the inspection step. If the amount is below a threshold, execute another payment bet (do this for each provisionally winning claim or subject all these claims together to a 1/N chance of winning). If a claim loses the bet at this step, it is disqualified. If it wins, go to the inspection step.

12. Inspect (12) the provisionally winning, eligible claims.

13. If a claim is invalid, disqualify it (13). If a claim is valid, register the fact (13) and notify (14) a payment process that the referrer who entered the claim is owed the payoff from the payment bet(s) the claim was exposed to in the MPSC.

1. Provide Referral Fee Offer.

In this step, a seller supplies a referral payment offer, all or part of which is registered (stored) by a computer database system that will then process referral claims. Accordingly, a system for executing the MPSC will include means for enabling a seller to enter a referral fee offer.

Certain terms of the offer will dictate key aspects of the processing of the claims—for example, the payoffs of the expected value payment bets that the system executes will be dictated by the terms of the referral offer.

Certain terms of the offer will not affect the processing of claims. But, the terms will be examined by an inspector when he checks whether they have been fulfilled by a referrer—for example, a term that does not affect processing, but that needs to be inspected is a term specifying who the referrer must communicate with when making a referral.

Terms of a Referral Offer

Referral payment offers are infinitely variable. Here we list some of the kinds of terms that such an offer can include:

The seller (the individual or entity) that is making the referral payment offer

The product/service to recommend

For example, a service could be a “listing in the Y-Pages.”

The prospect—the company or organization—to target

The MPSC is designed to enable a seller to encourage Rays (“grassroots referrers”) to communicate with a company/organization prospect. Rays could be told to recommend the Y-Pages to any organization, or to a certain group of prospects, such as “Miami companies,” or to a single prospect, such as “Sears.”

Who to communicate with

For example, Rays could be told to speak to a marketing manger. Or they could be told to email, say, customerservice@ Sears.

When to communicate with the target

For example, Rays could be told to communicate during business hours. Or, they could be told to communicate by a certain date.

The commission amount or rate

For example, the Y-Pages could offer Rays a fixed fee, such as $2 EV. Or, it could offer them a percentage of the revenues generated from Sears. (A commission may also be an amount of goods or services. The amount is subject to Expected Value Payment Bets and is equivalent for our purposes to money.)

The timing of the commission (e.g., monthly or lump sum)

For example, the Y-Pages could offer Rays a commission that is calculated one time only, or periodically. For instance, in cases where sales are ongoing, as in a monthly service contract, the commission can be accumulated over a period of time, or it can be calculated periodically.

The number of eligible referrers

For example, the Y-Pages may limit the number of Rays who can collect for a sale to Sears.

The splits among referrers

A commission can be split in an infinite variety of ways. The simplest is an equal division, but the Y-Pages could stipulate more complicated schemes. For instance, the first ten Rays might be paid more than the second ten Rays.

The terms of the EV payment bets executed in the MPSC

For example, the payoff can be stipulated.

The expiration period of the claims

For example, the Y-Pages could stipulate that a claim is invalid if a sale does not occur within 60 days of time that Ray makes his recommendation to Sears.

The deadline for submitting a claim (usually this will be some time before a sale occurs or at the time of sale—i.e., no claim will be allowed after a sale has occurred. But, it is possible for referral claims to be allowed after a sale has occurred, where a referrer is allowed to claim a referral after a sale has been made.

All such terms do not have to be entered into a system for executing the MPSC; they can be standard, meta-terms that are understood by users.

(The system for executing the MPSC can include means for transferring payment from the seller to referrers. Such means can include well known methods of depositing money into a seller account and then transferring it ultimately to a referrer.)

What a Referral Payment Means in the MPSC

Let us elaborate on what we mean by “payment” in the MPSC. In the MPSC, when Ray submits a valid claim, he is entitled to a share of a sales commission, as specified by the payment offer. Thus, he is paid with this virtual share. For example, if the Y-Pages offers each Ray an equal share for calling Sears, up until a sale is made, and if 100 people call, then each is entitled to 1% of the commission.

But, Ray is not paid with a definite amount of money. He receives the right to participate in a bet in which his expected value=his share of the commission. This means that if he wins the bet, his share is multiplied by the factor implied by the bet. In other words, he receives an expected value payment that is equal to his share of the commission. Two examples will illustrate.

Illustration 1: Assume that Ray is owed an expected 1% of a $10 commission, which means he is owed 10 expected cents. Assume a bet is executed in which his probability of winning is 1/1,000. Then, if he wins, he is paid a definite $100.

Illustration 2: Assume a referral offer stipulates that each referrer, up to the first 50, will be paid with $1 EV if a sale is made to Sears. Assume that a sale is made and that Ray is owed $1 EV, his share of the commission. Then, a bet is executed in which his probability of winning is 1/N. If he wins, he is paid $N dollars in definite money.

2. Register Referral Claims in a Claims Database.

In this step, the referrer submits a referral claim that the system stores as a claim record in a claims database.

A valid claim represents a share of a potential commission. In many implementations, the exact commission will not be known until a sale is made. And, if the sale is an ongoing one—for instance a monthly service contract—then the total commission may not be known until the end of a customer's relationship with a seller.

The MPSC can handle this kind of uncertainty because a claim entitles the referrer to a chance at a winning a share of the commission times a payoff multiple, provided the claim wins an EV payment bet selection. If the claim wins, and if there is a commission to be paid, then the commission can be determined, and the referrer is paid his share times the payoff multiple.

The claim can include some or all of the following information:

The referrer's identity

The prospect the referrer communicated with

The product/service the referrer recommended

The person the referrer communicated with (the prospect and person may be the same, or the person will work for the prospect, which is an entity)

How the referrer communicated the recommendation

When the referrer communicated the recommendation

Where the referrer communicated the recommendation

When the claim is registered (stored) by the database system, it is timestamped.

Submitting a claim

Ease of entering a claim may be crucial to induce referrers to use the MPSC. Thus, a key aspect of the MPSC is that it can incorporate methods for enabling referrers to submit claims easily.

These methods can be incorporated because a small amount of information may suffice for a claim. Moreover, tricks can be used make submitting claims easy. Easy input methods, such as leaving a voicemail, can be used. And, “compression techniques” can be used in which people are only asked the minimal amount of information necessary to verify a claim. For example, a referrer could enter only the initials of a manager that he spoke to. As another example, a claim might only include a phone number to identify a prospect. People-friendly compression tricks work because in the Verification Stage of the MPSC, the compressed information can suffice.

Let us look at three illustrations of how a claim could be submitted easily (these illustrations are not intended to limit the scope of methods for submitting a claim).

A. Submitting a Claim Through an Online Form

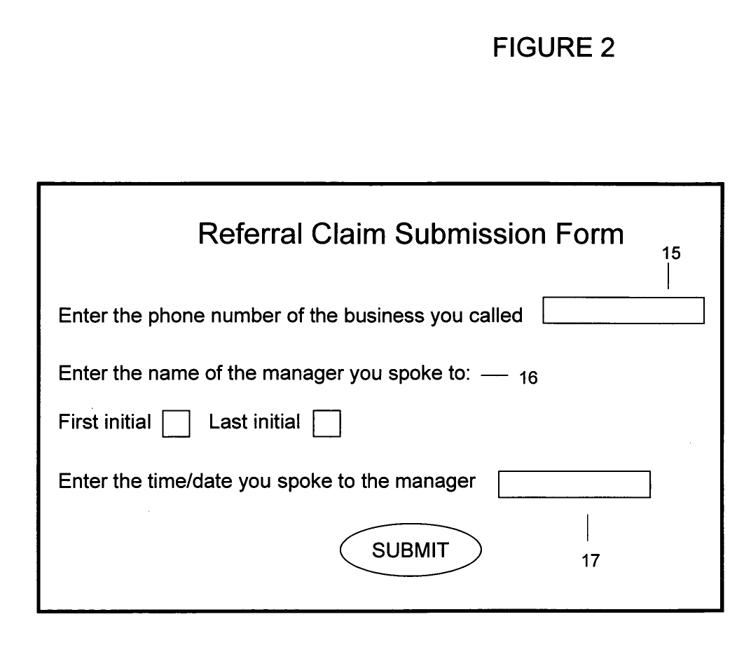

FIG. 2 shows a representative online form that could be used to submit a claim. Before entering claim data into the form, the referrer could be automatically identified by a cookie mechanism or the equivalent, so his ID data could automatically be added to the claim. The form includes a field for entering the phone number (15) he called, the abbreviated name of the person he spoke to (16) and the time/date (17) he called.

B. Submitting a claim by Email

A short email message can also suffice as a claim. The email address could identify the referrer and a few lines of text could supply the rest of the claim data. The email address that the referrer sends to would include means for storing the email in a claims database.

Further, to make the MPSC even easier, the MPSC could enable the referrer to send an email recommendation to a prospect and a copy (a “Cc”) to an address for submitting claims. For example, the following message could be sent to service@Sears.com and a copy sent to claims@grassroots.com:

Dear CEO and Vice President of Marketing,

I would prefer that Sears advertises to me through the Y-Pages.

Thank you,

Ray

The content of the message, the sender's email address, the recipient's email address, and the timestamp could suffice as a claim.

C. Submitting a Claim Through an Voicemail

Another easy way to submit a claim is through leaving a voicemail message that is processed by a front-end system that can store such messages in a claims database.

A voicemail claim could be a simple message, even one that cannot be deciphered by a voice recognizer. For example, Ray could call an interactive voice response system (IVRS):

IVRS: Please tell us the company you spoke to, who you spoke to, and when.

Ray: I called Sears today and spoke to Tom Jenks, marketing manager, and told him that I thought Sears should use the Y-Pages.

If claims need to be matched up for a particular prospect, a phone number for the prospect could label a voicemail message. For example, if Ray entered Sear's phone number, then the phone number could label the message as a claim that Ray called Sears. Thus:

IVRS: Please use your keypad to enter the phone number of the prospect you called.

Ray: 800-GO-SEARS.

IVRS: Please tell us whom you spoke to.

Ray: I spoke to Tom Jenks, marketing manager.

As another example of how voicemail could be used, it is also possible for Ray to do a “conference call” in which one party is Sears (the prospect) and the other party is a voicemail system that captures Ray's call to Sears—this method is analogous to the email method above in which Ray sends an email recommendation to Sears (the prospect) and copies an address that receives and registers claims.

Similarly, with an appropriately programmed phone system, Ray could call a prospect and, upon terminating the call, could press a button on his phone that automatically calls a voicemail system for registering claims. The system could capture the previous number that Ray called.

3. Disqualify Ineligible Claims.

In this step, the system can use automated tests to ensure that only eligible claims have the chance to win EV payment bet payoffs.

There may be several different eligibility conditions that the system can check for at this stage. For example:

Duplicate submissions can be designated ineligible.

Claims that have already been exposed to an EV payment bet can be designated ineligible. For example, a claim may be subject to an EV payment bet once a month. In this case, once it is subject to a bet, it would be ineligible for the monthly period, after which it could be subject to a new payment bet.

Claims that are expired can be designated “expired.”

Claims that are past a certain limit can be designated ineligible. For example, the Y-Pages may only offer the first twenty referrers the opportunity to share a commission. Any claim after that would be ineligible.

Disqualification of claims can be done at the inspection stage of the MPSC as well. Disqualification tests can also occur at other stages in the MPSC. In other words, disqualification does not necessarily need to be done directly before an EV payment bet is executed for a claim.

4. Randomly Select Eligible Claims with a Probability of 1/N.

Periodically, eligible claims are exposed to a random selection in which their chance of being selected is 1/N.

Depending on the referral offer, a claim may be exposed to a random selection—an EV payment bet, that is—one time only, or periodically.

Periodic bets are suitable if commissions are periodic, e.g., monthly, and also if referrers prefer to find out periodically whether they have won or not.

Random selection can be done such that each claim is exposed (independently or altogether) to a random selection of 1/N, such that more than one claim can “win” the selection process.

Alternatively, a group of claims could be designated as a group and one claim could be randomly chosen from the group, with a probability 1/(number of claims in the group), as a “first-stage winner.” Then this winning claim can be subjected to second EV payment bet selection.

5. If any are Selected, They are Designated Provisional Winners.

The random selection is an EV payment bet execution in which a winning claim is provisionally owed N times its original value—N times its share of a sales commission, provided that there is a commission and provided that the claim fulfills all the eligibility conditions of the referral offer. Thus, winning claims are designated “provisional” winners.

6. Periodically, Check if a Sale has Occurred.

In this step, the system or a system operator or the referrer checks if a sale has been made, resulting in a commission being owed.

The system checks if it includes means for automatically registering a sale.

If the system cannot automatically register a sale, then a system operator needs to find out if a sale has been made, and report that fact to the system, which registers the sale.

Alternatively, in certain implementations, the system can send an alert to the referrer whose claim is a provisional winner. The alert can ask the referrer to find out if a sale has been made and report that sale to the system, which registers the sale.

The registration of a sale can include the following information:

The buyer (this information is matched against the prospect data in a referral claim)

The seller

What was purchased

The amount of the sale

When the sale was made.

7. If No, Continue Registering Claims. If Yes, Disqualify Claims Registered After the Deadline for Referral Claims has Expired.

If a sale has not occurred then the system keeps registering eligible claims.

If a sale has occurred, then, the system will check whether claims entered are past the deadline for submitting claims. This deadline will usually be the time of the sale or some time before the sale. A time period after the sale is possible. Whatever the deadline, the system will disqualify claims that have been entered after the deadline.

There will be a gap between the time a claim is submitted and the time of a sale. For example, assume that Ray submits a claim on Thursday, and it is a winner. Ray checks on Friday whether a sale has been made. If the sale occurred on Wednesday, and if the deadline for referrals was before a sale occurred, then Ray's claim would be disqualified.

8. Calculate Total Commission.

If a sale has occurred, the commission is calculated.

A commission may be set at a static amount, which means it does not usually have to be calculated. Often, commissions are a percentage of a total sale, of course.

But, in many sales situations, the total commission might not be known because the revenue from the sale may accrue over time as, for example, in the purchase of a monthly service contract, or a multiple sale commitment, as in with an ad listing that is paid monthly, or in the signing of a lease. Thus, as with any commission, the “total” commission can be calculated for a particular period of time, as the particular implementation dictates.

The MPSC can handle periodic commissions by executing payment bets periodically for a given claim. Alternatively, one payment bet can be made that applies to each periodic commission. Alternatively, a commission can be accumulated over time, and then the single payment bet result can apply to that commission. The point is that the method can accommodate commissions that are paid based on the ongoing and uncertain revenues from a sale.

(We should also note that in certain implementations, the total commission might need to be greater than a threshold amount in order for the processing of a commission claims to continue.)

9. Calculate Each Individual Claim's Share of the Total Commission.

Each eligible claim is entitled to a share of the total commission. For example, if 100 people contact Sears, and Sears buys a listing in the Y-Pages, and the commission is $100 per month, then each eligible claim is owed $1 EV per month.

To calculate an individual claim's share of the commission pot, the system must determine how many eligible claims there are. To do this task the system can count the eligible claims in the claims database. However, there may be complications.

One complication is that a referral offer may stipulate that different claims receive different shares of the commission pot. For instance, the Y-Pages might offer to pay the first ten claimants more than the second ten. Payment offers are infinitely variable, which means that the formula for calculating an individual claim's share of a commission can be equally variable.

Thus, the MPSC will need to include a share calculation formula for determining each eligible claim's share—each referrer's share—of the total commission. This formula can use the claims data and the inspection data (see later steps) that the system registers.

A second complication is that all the claims that pass initial disqualification tests are not necessarily eligible because they may be invalid for a reason that can only be found by a human inspection. Yet, almost all claims are not inspected.

So, one way to proceed is to estimate the percentage of submitted claims are eligible. The MPSC can calculate this estimate using a claim count adjustment formula that can use data from the claims database or sampling data collected by system operators. For example, assume that on average, ¼ of claims that pass initial disqualification tests turn out to be ineligible in the inspection phase. That leaves ¾ eligible. Thus, the claim count adjustment formula might assume that only ¾ of the claims will be eligible. By assuming that some percentage of the claims will turn out to be ineligible on average, each claim will be worth more (in this case, each claim would be worth 4/3 times it's share by straight division).

Another way to proceed is to assume temporarily that all of the claims are eligible and wait until the inspection step to disqualify the winning but ineligible claims. After the inspection step, the system can then determine the share of the amplified commission that each of the eligible, winning claims will receive. For example, assume that 3 claims are provisional winners and each is provisionally owed $100 out of a total commission payoff pot of $300. Now, assume that at the inspection stage, one claim is deemed ineligible. This leaves $300 to be split by both of the eligible, winning claims. (The division of the commission payoff pot can be split differently, depending on the rules of the particular implementation of the MPSC. See the description of Step 13, Part 1, below.)

The point is that there are different ways to calculate a claims share of the commission pot, which will depend on the implementation. There is no perfect way because the MPSC is a probabilistic system that accepts imperfect information about claims in order to gain efficiency.

10. Provisional Winners are Owed Their (Individual Commission's)×(N).

Once an individual supporter's share is determined, then the provisionally winning claim has a provisional payoff value of the (individual's share)×(N).

For example, assume that Ray the referrer submits a claim for recommending the Y-Pages to Sears, and assume that 100 eligible claims have been submitted, and that Sears buys a listing for $100 a month, and that the commission rate is 10%.

Then the commission is $10 per month, and Ray's share is one hundredth, or 10 cents. These 10 cents are multiplied by N to yield Ray's provisional payoff.

11. If the Amount Provisionally Owed is Above a Threshold, Go to the Inspection Step. If the Amount is Below a Threshold, Execute Another Payment Bet for Each Provisionally Winning Claim Individually or All the Claims Together. If a Claim Loses the Bet at this Step, it is Disqualified. If it Wins, Go to the Inspection Step.

If Ray's initial, provisional payoff is too low, then it may not be cost-effective to inspect Ray's claim and transfer the payoff. So a second EV payment bet can be made with a higher payoff, a payoff that justifies inspecting his claim and transferring payment.

For example, if Ray is owed an initial, provisional payoff of $20, a second bet may be made in which he has a ⅕ chance of winning $100.

Note: a threshold test may not be necessary in certain implementations.

Now, if there is only one Ray whose claim is a provisional winner, then the EV payment bet will only apply to this one claim.

If there is more than one Ray, more than one provisionally winning claim, that is, then separate, individual EV payment bets can be made for each claim. Or, one EV payment bet can be made for all the claims together—all are then winners or all are losers. Let us take each case.

If a separate bet is made for each claim, then each claim that wins the second bet will have a provisional payoff that is equal to the payoff multiple of the bet times the claim's share of the first payoff. For example, assume that a claim's share of the first payoff from the first EV payment bet selection is $1. And assume that the second bet has a multiple of 50, a probability of winning of 1/50, that is. Then, if the claim wins the second bet, it has a provisional value of $50. (This amount may be further modified at the inspection stage.)

If all the provisionally winning claims are subject to a second EV payment bet together, then they are all losers or all winners. If they are all winners, then they will split the payoff from the second bet. For example, assume that there are 10 provisionally winning claims that have a share of a $40 payoff. And assume a second EV payment bet is applied to all the claims together, with a 1/50 probability of winning. Then, if they win this bet, they will provisionally share a payoff pot of $2,000.

12. Inspect the Provisionally Winning, Eligible Claims.

Assuming Ray's claim has won a large enough payoff, it is time to inspect his claim.

An inspector calls up the claim data from the claims database, and checks the data to see if Ray's assertions in his claim are true.

For example, Ray may have said that he spoke to Jane Jones at Sears to tell her to use the Y-Pages. The inspector can check if Jane Jones even works at Sears and in what capacity.

The inspector then can approve or reject (disqualify) the claim.

(Since inspecting a claim requires labor, the MPSC can also include steps in which Ray is required to put up a deposit to guarantee that the claim is valid, or a fee to pay for the inspection. This kind of payment encourages Ray to be honest. We do not elaborate on these steps.)

13. If the Claim is Invalid, Disqualify it. If a Claim is Valid, Notify a Payment Process that the Referrer who Entered the Claim is Owed the Payoff Amount from the Payment Bet(s) that the Claim was Exposed to.

If the inspector disqualifies the claim, the disqualification is noted in the claim record in the claims database. The referrer may be notified or not. (The method may include procedures for enabling a referrer to appeal the inspector's decision, but we do not elaborate on this possibility.)

If the claim is approved, the approval is noted in the claim record in the claims database. Ray is owed the payoff of the EV payment bet(s) that his claim was exposed to.

After the inspection, the amount of money that Ray is owed may be adjusted further to account for provisionally winning claims that were disqualified during the inspection step. (This possibility was discussed in the description of Step 9, above.)

To repeat from above, assume that 3 claims are provisional winners and each is provisionally owed $100 out of a total commission payoff pot of $300. Now, assume that at the inspection stage, one claim is deemed ineligible. This leaves $300 that can be split by both of the eligible, winning claims. As another example, assume that there are 3 provisionally winning claims, each of which will be owed $100 as a result of the EV Payments bets it has been exposed to. And assume that each claim has been increased in value at Step 9 to account for the estimated percentage of registered claims that are ineligible. Further, assume that one of the claims is disqualified. The other two, eligible winners, may or may not receive an increased payoff due to this disqualification, because these claims have been already been increased in value at Step 9.

Thus, the MPSC may or may not include, along with or as part of its share calculation formula, a final adjustment formula for increasing the amount that a winning, eligible claim will receive, if there were other claims that were disqualified at the inspection step that had a provisional share of the same payoff that the winning eligible claims had. Final adjustment formulas will vary depending on the implementation and the rules provided in the referral offer for splitting a commission among a group of referrers.

The system can transfer payment if it includes such means. We will assume that the system simply passes a message to a payment process that handles the well-known details of transferring a definite payment to a recipient.

Creating Additional Bets for Entertainment Purposes

One feature that can be added to the MPSC is an extra bet step such that referrers whose claims have won an initial bet can be alerted that their claim has “won the first stage.” Additional bets can be introduced for entertainment purposes.

### Part 2: The Method Using a First EV Payment Bet After Registering a Sale

Steps of the Method Using a First EV Payment Bet After a Sale Is Registered

In the second embodiment we describe, an EV payment bet is first executed after a sale is registered. This embodiment is well suited is to applications in which a sale is registered automatically by the system that executes the MPSC.

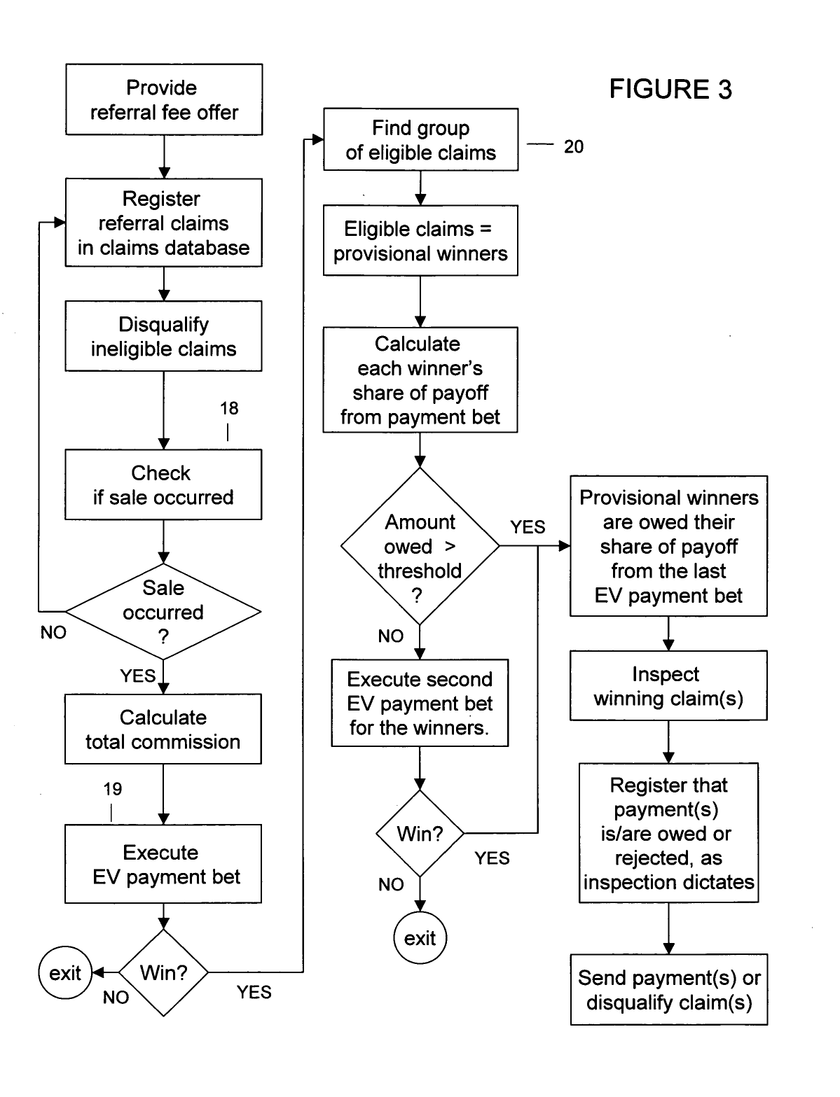

As shown in FIG. 3, the second embodiment of the MPSC comprises the following steps, which we list below. We will describe the steps that differ from those of the first embodiment.

1. Provide referral fee offer.

2. Register referral claims in a claims database.

3. Disqualify ineligible claims.

4. Check (18) if sale has occurred.

5. If yes, calculate the total commission.

6. Execute (19) an EV Payment Bet.

7. If the result is a loss, exit. If the result is a win, find (20) the claims eligible for payment.

8. Eligible claims are provisional winners.

9. Calculate each winner's share of the payment bet payoff.

10. If the amount owed is greater than a threshold, provisional winners are owed their share of the payoff. Go to the inspection stage. If the amount is below a threshold, execute a second EV Payment bet for all the provisionally winning claims together or individually.

11. If the result for a claim is a loss, exit. If the result is a win, provisional winners are owed their share of the EV payment bet payoff. Go to the inspection stage.

12. Inspect the provisionally winning, eligible claims.

13. If a claim is valid, notify a payment module that the referrer who entered the claim is owed the payoff amount from the payment bet(s) it was exposed to. If the claim is invalid, disqualify it.

1. Provide referral fee offer.

Same as first embodiment.

2. Register referral claims in a claims database.

Same as first embodiment.

3. Disqualify ineligible claims.

Same as first embodiment.

4. Check (18) if sale has occurred.

At this step the system, through automated means, periodically checks whether a sale has occurred, and if a sale has not occurred, it will keep checking. For example, assume that the Y-Pages is an online, commercial directory that registers sales automatically. Then, if Sears signs up and pays, the Y-pages will register that sale.

If a sale occurs, the system registers the sale, recording the following information:

The buyer (the buyer ID data is matched against the prospect data in a referral claim)

The seller

What was purchased

When the sale was made

The amount of the sale

We assume that the Y-Pages automatically registers revenue that accrues from the Sears listing.

The sale sets off a chain of events in which the commission is calculated and referrers are, possibly, paid off.

5. If yes, calculate the total commission.

There is no difference here from the first embodiment, but it may be worthwhile repeating that the commission can be calculated over a period of time, as revenues are realized over time, and not just directly after the sale is registered.

Continuing from the example in Step 4, assume that the Y-Pages calculates a sale of $1,000 in February, and then calculates a commission of $100.

6. Execute (19) an EV Payment Bet.

Here the system executes an EV payment bet in which the EV=the total commission. If a payoff is won, then all the eligible claims are owed their share of the payoff.

The payoff in this bet can be set as a static amount of money, or as a specified multiple of the commission.

Continuing from the example in Step 5, assume that a bet is set such that the payoff is $2,000: (the probability of a winning result would be 1/20).

7. If the result is a loss, exit. If the result is a win, find (20) the claims eligible for payment.

If the result of the EV payment bet is a win, then the system must know all of the eligible claims in order to calculate each claim's share of the payoff.

Continuing from the example in Step 6, if the result is a win, then all the eligible claims are owed their share of the $2,000 payoff. Thus, it is necessary to find all the eligible claims.

(If the system can search the claims database to find all the eligible claims, it does so. We assume that it can, if the claims database is only accommodating one referral offer. But, if a system must accommodate multiple prospects, or multiple offers from different sellers, then finding the eligible claims may be more complicated. We take up this situation in Part 3.)

8. Eligible claims are designated provisional winners.

This step is the same as in first embodiment. However, it is worth noting that in this embodiment there may be a large number of provisional winners, whereas in the embodiment of Part 1 of Book II, in most implementations, there will usually be a small number, often just one.

Continuing from the example in Step 7, let us assume that 50 referrers called Sears and submitted claims. Then each is a provisional winner.

9. Calculate each winner's share of the payment bet payoff.

Same as first embodiment.

(Continuing from the example in Step 8, let us assume that each claim is owed an equal share, which means that each is owed $2,000/50, which is $40.)

10. If the amount owed is greater than a threshold, provisional winners are owed their share of the payoff. Go to the inspection stage. If the amount is below a threshold, execute a second EV Payment bet for all the provisionally winning claims together or individually.

Same as first embodiment (see Step 11 of Part I).

(Continuing from the example in Step 9, if $40 is enough to justify inspecting the claims individually, then skip to the inspection step. If $40 is not enough, then another bet can be executed that applies to all the claims. Or, separate bets can be made for each claim, which may be preferable because it can mean a lower exposure for the payer of the commission.)

11. If the result is a loss, exit. If the result is a win, provisional winners are owed their share of the EV Payment bet payoff. Go to the inspection stage.

Same as first embodiment.

12. Inspect the provisionally winning, eligible claims.

Same as first embodiment.

13. If a claim is valid, notify a payment module that the referrer who entered the claim is owed the payoff amount from the payment bet(s) it was exposed to. If the claim is invalid, disqualify it.

Same as first embodiment.

Special Case of Having Only One Referrer Being Paid (a Group of One)

We note that the MPSC, as described in Parts 1 & 2, can also be used to pay a commission where a seller specifies that only one referrer will be paid a commission for a sale.

For instance, an online chocolate shop may offer to pay referrers for telling people about the shop with a limitation that only the first referrer who tells a prospect will be paid.

If the MPSC is used to handle this kind of referral payment offer, the MPSC will still use EV Payment bets to amplify the commission. But, the MPSC will be simplified such that formulas and functions for enabling the splitting of a commission will not be necessary.

What will be necessary is that referral claims need to be registered and conditions of the referral offer will need to be enforced. These conditions can include a first-to-refer gets paid rule, for instance. Many other conditions can apply that can be verified in the inspection stage.

The case where a seller specifies that only one referrer gets paid may be important, depending on how the MPSC is used in the marketplace. The MPSC offers transactional efficiencies not found in existing methods for paying a commission to a single referrer.

Part 3: Steps for Processing Multiple Referral Fee Offers Context

In Parts 1 & 2 we described the MPSC as a method that enables a seller to make and execute a grassroots referral payment offer, concerning a single prospect.

In practice, sellers will often make offers concerning more than one prospect. For example, a toy manufacturer may offer to pay people to contact any retailer who might be a prospect for buying toys. As another example, a commercial directory may offers to pay users for recommending the directory to any advertising prospect.

In practice, there will also be companies—sometimes called application service providers (ASP's)—that enable multiple sellers to use the MPSC, much as there are companies that handle coupon fulfillment for manufacturers. An ASP-operated MPSC system needs to be able to process multiple referral payment offers.

If there is more than one prospect, then a system that executes the MPSC needs to identify claims according to the prospects that they correspond to. The key problem to be faced is how to identify referral claims so that claims for the same prospect or offer can be matched up to yield the group of claims that share a commission.

In this part of the specification, we discuss steps that can be added to the embodiments of Parts 1 & 2 that enable a system to process claims for multiple prospects, and for multiple offers.

Before proceeding, let us note that if a system enables multiple sellers to provide referral offers, then the MPSC will include well-known steps for establishing seller accounts that enable sellers to enter offers, edit offers, deposit payment and, transfer payment. We will not delve into these methods because they are well known.

Illustrative Case

To see the problem and the solutions concretely, we will illustrate with the example of an online directory, the Y-Pages, the makes the following offer to users:

Anyone who recommends the Y-Pages to a business that subsequently becomes listed will receive a share of a referral fee. The fee is 10% of the amount the business spends in the Y-Pages. This offer is open to the first 100 referrers who submit claims for a particular business. These referrers will share the fee for that business equally.

The Problem: Identifying Claims and Offers

Claims need to be identified so that claims for the same offer and the same prospect can be matched up, in order to calculate each claim's share of a commission.

Let us digress a moment to discuss the need to calculate each claim's share of a commission accurately. It often will not be necessary to do a perfectly accurate calculation, in the sense that some claims may indeed be missed, may not get credit that is, because they cannot be found and matched with other eligible claims.

The importance of finding all the claims for a particular prospect depends also on the EV payment bet selection method used.

If the first EV Payment bet is executed after a sale is registered (the embodiment of Part 2), then, assuming a payoff multiple of N:

Commission Payoff=Total Commission×N

In this case, it does not matter necessarily if all the eligible claims are found. The ones that are found can split the Commission Payoff, and the process can be seen as reasonable.

But, if the first EV Payment bet is executed before a sale is registered (the embodiment of Part 1), then, assuming a payoff multiple of N:

Commission Payoff=(Total Commission)/(Eligible claims)×N

In this case, it is preferable to find all the matching, eligible claims because otherwise, the Commission Payoffs can be too high on average, due to the eligible claims being in the denominator of the formula.

So, the point is that in certain embodiments, finding, or accounting for all the eligible claims can be more important than in other embodiments. It will also depend on the implementation.

The problem of finding all the eligible claims registered for a prospect involves two questions:

How to identify which offer a claim corresponds to?

How to identify which prospect a claim corresponds to?

At first glance, the solution appears simple. Why not just assign each offer and each prospect a unique ID?

That solution may not suffice. First, the list of prospects might not be known. For example, if the Y-Pages pays people for contacting “any business that might advertise,” the names of these businesses may not be known in advance by the Y-Pages.

Second, unique identifiers are usually not user-friendly. That is to say, it is often difficult for people to remember a string of digits or a precise, unique name. Yet, user-friendliness—the ease of entering claims—is critical to making the MPSC useful.

What We Will Describe in this Part 3 of Book II of the Specification

As we delve into these issues, we will take the example of an online directory that makes the single offer above. We will not discuss the case of a system that handles offers from multiple sellers, because whether a system enables multiple sellers to make different referral offers, or a single seller to make one offer that applies to multiple prospects, the problem of distinguishing among claims is essentially the same. It is a match problem.

However, let us note that if the MPSC enables different sellers to enter payment offers into the system, then that the set of offers will almost always be far smaller than the set of potential prospects. Therefore, matching up claims that correspond to the same offer is usually a simpler matter than matching up claims that correspond to the same prospect. For example, if 1,000 sellers use the MPSC to enter payment offers, then a claim only has to be matched to one of 1,000 offers, which is usually a smaller set than the set of potential prospects, who are usually not pre-stored in the MPSC, as payment offers are, as for instance, in the embodiment of Book I.

Thus, the inventive method and system will include steps for matching a submitted claim to a corresponding offer in the system, if any such offer exists in the system. If such an offer does not exist, the system can inform the submitter that the offer does not exist.

So, we will assume that the problem is identifying which prospect a claim corresponds to, so that the claim can be matched up with other claims for the same prospect.

For example, assume that Ray submits a claim that he contacted Sears. And assume that Rita submits a claim that she contacted Sears. Then, a system executing the MPSC must be able to identify that both claims correspond to the same business, Sears. This problem can be subtle.

We will examine, one by one, the different ways that a referrer can report a recommendation: by email, by online form, and by voicemail. We will discuss problems in identifying a claim and describe solution steps that the MPSC can incorporate.

We will also discuss claims processing for each way that Ray can make a recommendation: in person, by phone, by online form, and by email.

We will then discuss steps for preventing the cheating that is possible when the name of a prospect or a product/service can be entered in different ways.

Finally, we will describe the use of an “extrapolation formula” as an alternative, or a complement, to matching a claim with other claims.

A. Submitting a claim by Email

Let us first consider the case of Ray submitting an email claim saying that he recommended the Y-Pages by an email to Sears.

As discussed in Step 2 of Part 1, a very easy means for submitting this claim is to send a copy of his recommendation email to a claim registration address. This method should suffice in most cases to identify the prospect because the email address of the prospect, e.g., service@sears.com, or at least the domain name, e.g., sears.com, should uniquely identify a prospect.

This method works where the primary problem is identifying a prospect, but in cases where an offer or a product/service has to be identified, such as a Sears Lawnmower, non-uniqueness problems may exist. These same problems exist when claims are submitted via online forms.

Next let us consider the cases of Ray submitting an email claim that he recommended the Y-Pages to Sears in person or by phone. These cases are equivalent to Ray submitting a claim through an online form too, because the same non-uniqueness problems apply. We discuss solutions below in the section on claims submitted through forms.

B. Submitting a claim by Voicemail

A very easy way for referrer to submit a claim is via voicemail. We will consider three ways that a claim left as a voicemail can be identified as corresponding to a particular prospect:

Using phone numbers as identifiers

Using machine matching of voicemail claims

Human inspection of machine matched voicemail claims

Using Phone Numbers as Identifiers

Let us assume Ray makes a recommendation by phone and then reports that recommendation by a voicemail message left with a claims registration system.

For example, let us assume that he has called Sears. As discussed in Step 2 of Part 1, a very convenient way for Ray to identify the prospect—Sears in this example case—is to use the prospect's phone number. For example, he can call the claim registration system and enter the phone number for Sears.

But, a problem may exist with phone numbers, which is that many businesses have more than one number, so a phone number may not be enough to match up all the claims for a prospect. For example, Ray may use a local phone number to identify Sears and Rita may use a toll-free one.

An automated, reverse lookup, using a comprehensive database of phone numbers may solve this problem adequately, matching up phone numbers that correspond to a particular prospect.

The a referral offer may constrain the phone numbers—for example, the offer term may require a local phone number.

If phone numbers are not constrained, solving the problem of multiple phone numbers may require that a system operator (a person) do some extra matching. Below, we discuss how human labor can be saved in this task, but first let us discuss automated matching of voicemail claims.

Using Machine Matching of Voicemail Claims

Another way to match claims according to prospects is for an interactive claims registration system to prompt Ray to state the name of the prospect he contacted, and then to use that name to match Ray's voicemail claim with other claims stored by the system.

Machine matching may be sufficient, depending on the implementation. Or, it might provide match data that an extrapolation formula (see Section E below) could use to estimate the number of actual matches stored in the system.

Or, machine matching might provide a set of matches that could be culled by a system operator. Below we discuss the case of using human labor—a system operator—to help match claims.

Human Inspection of Machine Matched Voicemail Claims

In this section we assume that a system operator (Sis) is needed to assist in finding the matches for a claim. At this point, the MPSC will have executed an EV Payment bet in which there is a winner. There will be one or more winning claims, and it is necessary to find the other claims for the same prospect, in order to make a share-of-the-commission calculation.

After the system database searches for matches, and outputs them to Sis, she can then assist in finding additional matches in the claims database and/or eliminating false matches.

First, we will assume that phone numbers are used to identify the prospect. We will imagine that, under the method of the first embodiment, that Ray has submitted a claim with Sears' local phone number, and that the claim has won. Now, we imagine that the system has found three other claims that have the same phone number as Ray's claim. But, Sis realizes that more than one phone number may be used for Sears. So, Sis may look in another directory to check phone numbers for Sears. Assume that Sis finds a few other phone numbers. Now, Sis can enter those phone numbers in to the claims database, searching for matches. For example, she might enter Sears' toll-free number, to see if any claims match that number. If Sis finds matches, say, two matches for Sears' toll-free number, then she can enter into the system that there are two more matches. This fact can also be registered in the claim record for Ray's claim.

Now, let's take a different situation. Let us assume that prospects are identified by speaking a name in a voicemail claim and that the names in voicemail claims are matched by machine (by a matching algorithm). Let us assume that Ray's claim has won and that the system finds 50 other claims that tentatively match Ray's claim. Sis can then listen to each tentatively matching claim and eliminate the false matches, leaving a set of actual matches.

Now, let's take a different situation. Let us assume that prospects are identified by text, by spelling that is. Let us assume that Ray's claim has won and that it has been matched up with 50 other claims. Sis can then review each potential match and eliminate, cull, the false matches, leaving a set of actual matches. Sis can go a step further, by entering other possible spellings into the claim database, looking for additional matches—Sis may be able to do this better than a machine in certain cases because human, common sense may be better suited to finding matches.

Now that we see how Sis can be used to assist in the matching process, the goal is to minimize the labor cost involved. Below we give two methods that can be used:

Set the EV Payment Bet Payoff High Enough

The first method is simply to set the payoffs of the EV payment bets high enough to justify the cost of having a human assist in the matching. For example, if the payoff is set at 10,000× the value of a claim, and a claim has a value of $1, then the $10,000 payoff may be worth the cost of human matching. How high the payoff needs to be depends on the implementation, of course.

Execute a Random, Pre-Selection Step of 1/Y Claims

Another way to reduce costs is to use a probabilistic counting trick. A random selection step can be taken such that registered claims are selected with a probability of 1/Y. The resulting set of claims can be used as the set that Sis uses to search for matches. The trick is that each claim found will represent Y other claims. For example, let us assume that Y=4. Then, it is fair to assume that each selected claim represents 4 claims, the one selected and three that are not.

The preliminary random selection step acts not only as a counting step, but can also act as part of an EV Payment bet such that the selected claims are worth Y times their original value. Another EV payment bet step will be taken to increase their value high enough to be paid off, but those claims that do not win this next EVpayment bet step will still be used as the set of claims that are searched by Sis to find matches.

How high should Y be set? That will depend on the particular implementation. Y is chosen by system operators and should be based on empirical data. For example, if an average prospect is only contacted by 5 referrers, then it is not fair to set Y at a number much higher than 5, because the assumption that each selected claim represents Y claims will not be true.

This specification is not the place to detail the counting theory; let us simply say that an additional random selection step can be used in the MPSC for the purpose of establishing a reduced set of claims that are to be searched for matches, to find the number of claims that have been submitted for a given prospect (or a given offer, or a given product/service).

C. Submitting a Claim by Online Form

Trying to match text claims submitted by online form (or by email) involves the match problems we have already discussed: different spellings for prospects, different possible locations for prospects, different phone numbers (if phone numbers are used as identifiers), different spellings for products/services (if it is necessary to enter this information).

For example, assume that Ray and Rita both submit claims for referring a dentist, Dr. Dale Otagaki, to the Y-Pages. Ray might spell the name as Dale Ottaguki, while Rita might spell it Dr. Otogaki. Both have in mind the same dentist, but they have spelled it differently. There may be no standard way to enter such a name. Should Dr. be used, for instance?

A variety of tricks can be used to constrain claim submissions. We have said that using phone number is a powerful constraint. It does not suit all applications, however. The match solutions concerning text claims are really no different than those supplied in the discussion of voicemail claims. To wit:

the system can perform machine matching of claims

the system can perform machine matching, and a system operator can then add to or cull the list of matches, using claims records in the claim database.

D. Detecting and Preventing a Double Entry Cheat

In cases where a claim can be entered under different identifiers, a referrer may try to cheat by entering a claim more than once. For example, Ray might enter a claim for Bob 's Bikes and Bob's Bicycles.

One way to prevent this cheat is to allow Ray to do it, but to penalize him if more than one claim is a winner.

Another way to prevent the cheat is to have the inspector do a lookup in the claims database to see what other claims Ray has submitted. Claims that appear to be duplicates can be nullified.

We should note that in some implementations, Ray might enter the same claim more than once in an honest effort to spell the prospect's name correctly. This multiple entry can be handled by having the inspector do a lookup and then discount Ray's payoff by a factor that depends on the number of duplicate claims he enters—i.e., if he enters two claims for the same prospect, his payoff can be discounted by 50%.

E. Alternative Approach: Using a Formula to Guess the Value of a Claim

It is costly for a system operator to help process matching claims. It would be cheaper if no human matching had to be done to find out each individual claim's share of a commission.

Ideally, we would like to enable Ray to simply leave a voicemail message, such as:

I called Sears at Fashion Square Mall and spoke to Tom Jenks the marketing manager and told him Sears should use the Y-Pages.

Ideally, no prefatory data enabling a machine to identify Sears would be necessary. The system processing claims could simply choose Ray's message, with a probability of 1/N. If the claim were picked, then it would be worth N times its share of the commission. A human inspector could verify the claim and not worry about matching it with other claims.

But, how to obviate the problem of finding all the other claims for that prospect, so that the system can calculate the share that Ray's claim deserves?

An alternative approach is to use an extrapolation formula that estimates how many valid claims have been made for the same prospect, based upon historical, claim data. For example, through statistical analysis of claim records, system operators might find that for every 2 referral claims found, 1 is missed, and consequently, they might create an extrapolation formula that assumes that each claim has a right to ⅔ of its apparent share −⅔'s is the share, on average, if all the claims were found, in this hypothetical example.

An extrapolation formula would not have to be used instead of machine matching of claims; it could use automated match data. For example, if machine matching finds 6 matches for a claim, a formula might then extrapolate that there are actually 9 claims that match the winning claim. In fact, if machine and/or human matching of claims are used, it is likely that an extrapolation formula will be used to adjust the match figures—this use of a formula is analogous to the use of an claim count adjustment formula, described in Part 1, Step 9.

We do not mean to oversimplify the idea of an extrapolation formula. The formula could be quite complex and depend on a variety of variables. For example, the number of referrers may depend on the size of a commission—i.e., more people may contact large businesses. The particular formula will depend upon the implementation and the experience of system operators, who will have to perform the statistical analyses of claim data. The formula will have to be set so that claims do not get paid too much, on average.

The point is that an extrapolation formula—one that estimates how many claims match another claim—is another way of calculating a claim's share of a commission.

In most cases, an extrapolation formula will be less accurate than a human assisted match process at finding a claim's proper share of a commission. But, the cost advantages may be so great that users will accept the seeming unfairness.

If a system that executes the MPSC uses an extrapolation formula, Ray could leave a message as in the example above, and not have to remember the phone number of a business or the exact spelling. His claim, if it is a winning one, could be deciphered by a human, who could verify whether Ray really did speak to Tom Jenks.

Such a formula can also be applied, of course, to claims submitted by email or online form.

### Part 4: Using Auditing to Prevent Cheating and Reduce Costs

The MPSC ensures that only valid claims get paid off because it includes an inspection step that verifies the data submitted for winning claims. Inspection takes place at the last or second-to-last step of the MPSC. The most important purpose of inspection is to keep users honest, to ensure that they have actually made a recommendation, and are entering true claim information—for example, a referrer who truly makes a verbal recommendation will be able to enter the correct name of the person he spoke to. Invalid claims are disqualified. Operators of the MPSC could impose stiffer penalties, such as banning a referrer from participating in any other referral payment offer.

An alternative to inspection at the last stage of the MPSC is auditing—inspection before the result of an EV payment bet is known. With a specified probability, claims could be audited at any stage, after they are registered in a claims database, not just after winning an EV payment bet. If the penalty for an invalid claim is stiff enough, the auditing could enforce honesty, and eliminate the need for an inspection only of winning claims.

(We note that if auditing at any stage is used to enforce honesty, then the role of the EV payment bets in the MPSC is to amplify the commissions so that transferring payment is worthwhile. However, if definite micropayments become cost-effective to do, then even EV payment bets themselves may not even be necessary to compensate referrers.)

If the MPSC employs inspection of winning claims, there is still a possible use for auditing. Rather than inspect all the provisionally winning claims, the method could audit a certain percentage, instead. Referrers who have provisional winners could be required to pay a deposit guaranteeing that the claims are valid. If the deposit were large enough, and the probability of being audited were high enough, only honest referrers would rationally submit deposits, and so, only honest claims would be paid off. Thus, the cost of inspection, perhaps the largest cost of operating the MPSC, could be reduced.

### Part 5: Providing Payment Estimate Statistics to Users

Providing Payment Estimate Statistics

If the MPSC processes claims for an offer made for multiple prospects, then a useful feature is to provide potential referrers with information for estimating how much they will be paid for making a recommendation. Accordingly, the MPSC can include payment estimating formulas that use historical data from the claims database to arrive at useful payment estimate statistics. (Some such formulas may require data that are not generated from claims data, but that are entered into the system database by system operators.)

If the MPSC includes such formulas, it will also include steps for enabling users to see the statistics. The statistics may be displayed automatically by a system in response to a user entering a prospect name. Or a system might enable referrers to query the claims database about prospects in general.

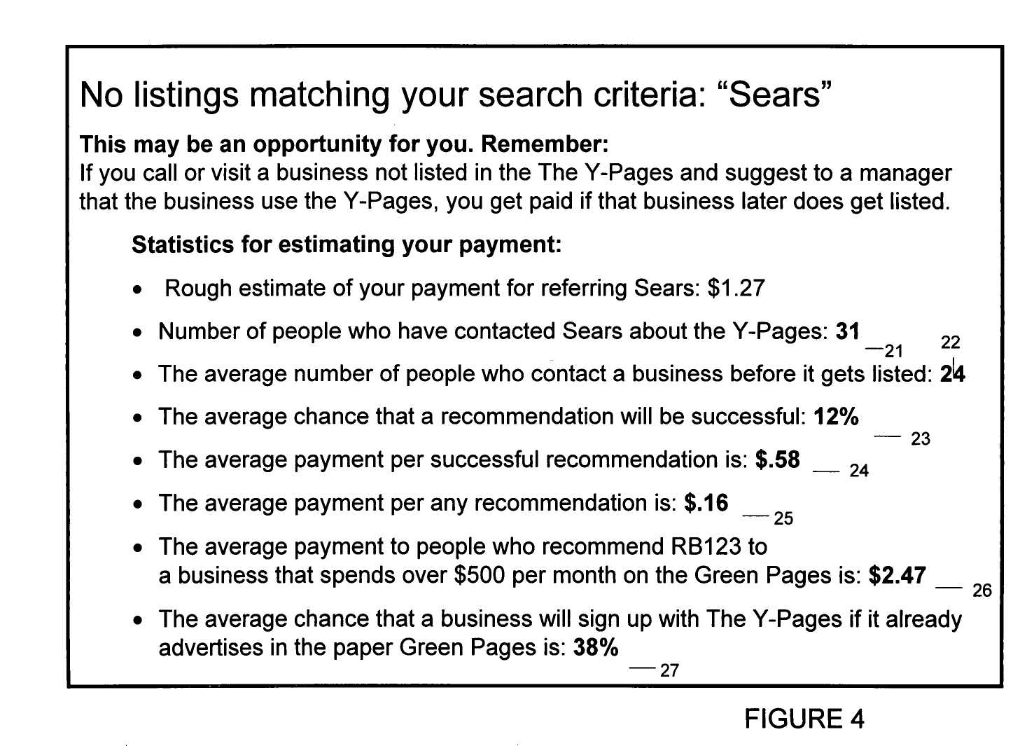

Here we will list some of the kinds of questions that payment estimate formulas can answer, as shown in FIG. 4:

An estimate of how much a referrer will be paid for referring a particular prospect

The number (21) of referrers who have already contacted a particular prospect

The average number (22) of people who contact a prospect before a sale is made

The average chance (23) that a sale will be made to a prospect

The average payment (24) for a successful recommendation

The average payment (25) for a recommendation, including unsuccessful ones

The average payment (26) to people who contact prospects with a given characteristic

The average chance (27) that a sale will be made to prospects with a given characteristic

(One important prospect characteristic that the system can use in the payment estimating formula to generate payment estimate statistics is the amount of money the prospect currently spends with a competitor to the seller offering the commission. For example, assume the Y-Pages' competitor is the Green Pages. In this case, it may be possible to project commissions from the Y-Pages based on how much a prospect, say Sears, currently spends on the Green Pages.)

In addition to the statistics cited above, a system operating the MPSC can show commissions paid for existing and past sales to customers. For example, if the Y-Pages has paid a commission for a sale to Home Depot, the system could show how much the commission is. This information can help Ray decide whether to make the effort to recommend the Y-Pages to Sears.

In addition to displaying such statistics, a system operating the MPSC can include means for enabling a referrer to enter his own estimate of the revenues from a sale. The system can include a formula for generating a commission estimate for him, based upon the user's estimate and the data in the claims database.

### Part 6: Using the Method to Populate a Commercial Directory

Business Problem: Populating a Commercial Directory

For companies trying to start a new commercial directory, one that charges advertisers for listings, an immense obstacle is the cost of populating the directory. Even if a new directory offers advantages, there is an enormous cost in trying to get the sales message through to advertising prospects. This problem is well recognized and has led to the demise of many a new directory, and has prevented people from trying to establish new directories. Not surprisingly, then, most of the leading Yellow Pages are those formerly owned by Ma Bell.

Of course, Yellow Pages are not the only kind of commercial directory. Online directories of websites are another example, as are product/service catalogues. Consider trying to start a universal catalogue of products, not just a list of sellers of products, but also the products themselves, along with all the sellers who sell them. It is possible to create such a directory, but it is also obvious that, under current sales methods, the costs would be prohibitive.

The MPSC Solution

In this part of the specification, we will consider how the MPSC can solve the problem of populating a commercial directory, especially an online directory. In our description, we will assume that the MPSC is incorporated into an online directory, i.e., the directory system will include a sub-system for processing referral claims according to the MPSC.

The MPSC can enable the directory to pay anyone, especially users of the directory, for recommending the directory to advertisers.

In fact, if a commercial directory incorporates the MPSC, an implicit feedback loop is created that provides users with either listings of businesses in the directory, or, implicitly, businesses NOT in the directory. That is to say, if a business does not appear in the directory, then the user knows that the business is a prospect.

(We note that in certain cases this loop could be made explicit, if the directory includes paying and non-paying listings. The non-paying listings could be labeled as “live prospects.”)

Let us illustrate with our Y-Pages example, which we will assume is an online phone directory. Let us assume that the Y-Pages makes a grassroots referral payment offer to people who recommend the Y-Pages to businesses. Now, let us consider the sequence of events for a user:

Assume the user does a lookup by business name

The user finds that the business name does not exist in the directory

Thus, the user realizes that he may get paid for recommending the Y-Pages to this business (further, since he is doing a lookup in the Y-Pages, there is a reasonable probability that he is planning to contact this business anyway—by calling, going in person, or visiting its website)

If the user contacts the business, he can recommend the Y-Pages

If he recommends the Y-Pages, he can submit a referral claim to the Y-Pages

The same process applies even if the user does a lookup by search term say, automobile. That is to say, if the directory returns listings for several businesses—say, dealerships—the user may see that certain dealerships are missing, and that they are good prospects for buying ad listings. A search term may be of any length.

Consider a hypothetical product catalogue, Product Pages, as another example:

Assume that the user enters the search term: Oakley sunglasses

The user finds a number of merchants listed under the term, but not The Sunglass Hut.

Thus, the user realizes that he may get paid for recommending to The Sunglass Hut that it get listed in the Product Pages under the product name, Oakley sunglasses.

In this case, the product/service that Ray is recommending is not just the Product Pages, but the Product Pages and the search term, Oakley sunglasses. Thus, the Product Pages could offer to pay people not just for recommending that businesses advertise, but also for recommending search terms to those businesses. Accordingly, different referrers could be paid for referring the same business, but with different payments corresponding to different search terms.

So, as explained above, an online directory system and include the MPSC such that the operator of the directory, the seller of directory listings, can provide a referral offer to users stating that users who refer any prospect will be paid a commission if a prospect buys a listing (a listing can be identified by the corresponding search term). The claims for this commission offer can then be processed using the MPSC, which can be integrated in the directory system.

Providing Payment Estimate Statistics—Creating Explicit Payment Feedback

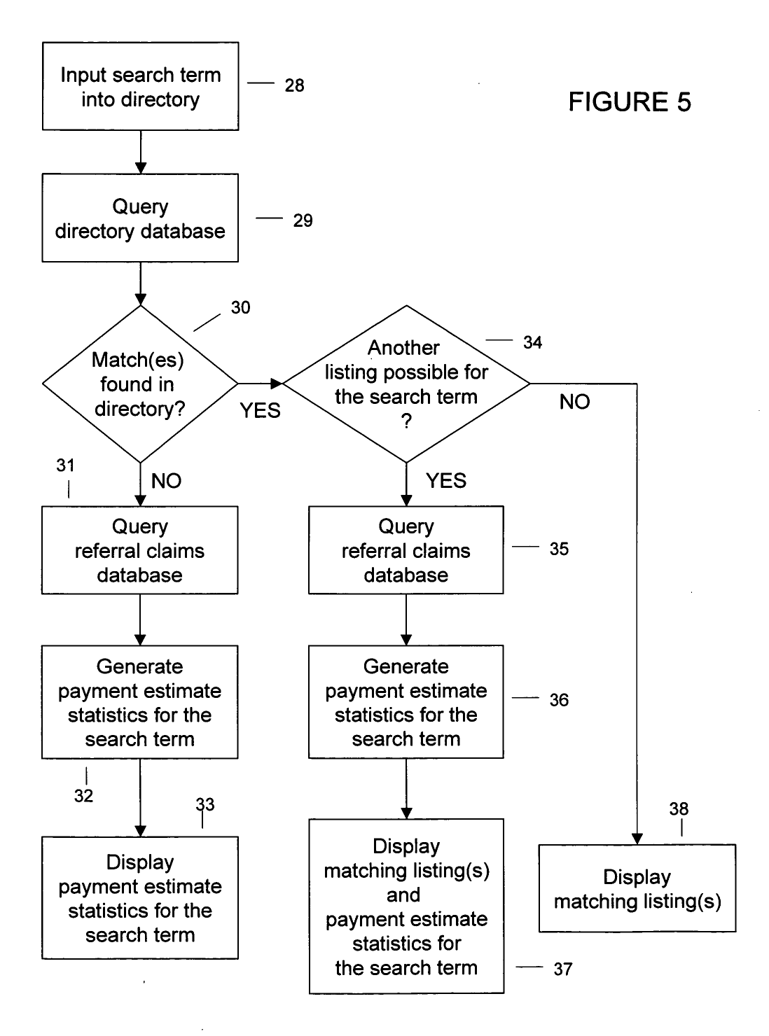

Taking up the payment estimating features described in Part 5, we realize that we can create a explicit payment feedback loop within an online directory that incorporates the MPSC. Using the methods of Part 5, the directory can provide users with payment estimate statistics. Thus, as shown in FIG. 5:

A user enters a search term (28), for example, Roma Barbers

The directory queries (29) its database and does a lookup (30)

If no match is found, the directory:

Queries (31) a referral claims database

Generates (32) payment estimate statistics that correspond to the search term

Displays (33) the payment estimate statistics

If a match is found, and other listings are possible (34) under the search term:

Queries (35) a referral claims database

Generates (36) payment estimate statistics that correspond to the search term

Displays (37) the payment estimate statistics

If a match is found, and no other listings are possible under Roma Barbers, then the directory displays (38) the matching listing.

We should note that in many implementations, the directory system would not be able to know whether more listings are possible under a search term. The directory can either be set up as a directory in which there is only one paying listing per search term. In this case, the directory does not need to show payment estimate data along with a listing. Alternatively, in a directory where there is more than one possible prospect under a search term, or where the directory cannot detect whether more than one listing is possible, the directory can then default to always showing payment estimate data.

Payment estimate statistics that “correspond to the search term” may specifically use data on similar search terms, or less specific averaging data. One way to provide useful payment estimate statistics is to show the commissions being paid for similar listings, such as the listings under the search term. Thus, a directory can automatically show the commissions paid on a listing, or can enable users to do a query to find out.

Another way is for the directory to track how many times a search term has been entered by different users, and to show that number, which can also be plugged in as a variable in a payment estimating formula.

We should note that, in certain implementations, payment estimate statistics might only be averages that apply to all claims. Such averages could be posted on the directory's homepage or on a special page for showing the payment estimating statistics. In other words, the statistics do not have to be shown along with directory listings.

### Book III

### Methods for Transferring Payment in EV Payment and Verification Systems

Note: In this Book III, the invention and the inventive method will refer to the inventive methods described in this Book III. Likewise, the invention and the inventive system will refer to the inventive systems described in this Book III.

The methods described in this Book III apply to situations in which a payment system enables a payer to pay a recipient an EV payment provided that the recipient meets specified conditions that are verified and/or tracked using the system.

This Book III elaborates on a method of using two EV payment bets to transfer a payment from a payer, through a system, to a recipient. In this method, the payer takes the payoff risk in the first bet while the system takes the payoff risk in the second bet.

In addition, this Book III describes a method for paying an EV amount that is based on a percentage of a purchase amount. This description is included here for the sake of completeness, but has already been disclosed in the above referenced applications.

In addition, this Book III describes how EV payments can be capped when EV payment is based upon a percentage of a purchase amount.

In addition, this Book III repeats descriptions in one or more of the above referenced applications of how transaction costs can be reduced with the use of deposits.

Other sub-methods are described that have been included in one or more of the above-referenced applications.

### Contents of Book III

Introduction:

How the Specification of Book III Is Written

Where the Inventive Methods Apply

Inspection (Verification) Process Reviewed

Example Scenario

Definitions for Book III

(Note: “Parts” below refer to Parts of this Book III)

Part 1: Payer Takes All the Payoff Risk

Part 2: System Takes All the Payoff Risk and Refunds Invalid Payoff claims to Payer

Part 3: Two-Bet Process Where Payer and System Take Separate Payoff Risk, in which the First Bet Payoff Is Deducted from Payer

Part 4: System Takes All the Payoff Risk and Uses a Discount Formula to Adjust for Invalid claims

Part 5: Two-Bet Processes in Which EV Payment Equals a Percentage of a Sale

Part 6: Using Deposits to Reduce Inspection Costs

Part 7: Miscellaneous Sub-Methods for Efficient and User-Friendly Transactions

### Introduction

How this Specification of Book III is Written

This specification is organized as a set of descriptions of modules (sub-processes) that together comprise the inventive method. The modules are high-level descriptions that we use for clarity. The modules themselves can be decomposed into smaller sets of steps, and rearranged, as is apparent to those skilled in technical writing or programming.

The modules may be performed on a single, “central” database system, or they may be performed by “separate” computing database entities that communicate with each other.

The goal of this specification is to disclose the novel aspects of the inventive method and system. There is no ideal way to present these aspects, and so, those skilled in technical writing or programming will see better ways to organize and present this disclosure.

Example cases are provided. Those skilled in the art will know that these examples are illustrative only and do not limit the range of applications of the present invention.

Many of the options described in this specification, such as certain terms of EV payment bets, may be held standard in practice. Those skilled in the art will readily see where a user option may be converted into a default.

We omit descriptions of the various methods that the inventive systems can include for charging users because these methods are well known and do not add to the disclosure.

Where the Inventive Methods Apply

The methods described in this Book III apply in payment systems operated according to a method that enables a payer to pay a recipient an EV payment, if the recipient meets specified conditions, which are probabilistically verified and/or tracked using the system.

We call this method the expected value method for paying and verifying (EVMPV). We call an online database system operated according to the EVMPV by the name expected value system for paying and verifying (EVSPV).

The EVMPV is a method for operating an online database system comprising the following elements and steps that are tailored in novel ways to solve specific problems:

1. A payer ID and bank account are established

2. A system account bank account exists

3. A payer posts a payment offer in the system

4. The offer is findable and selectable (acceptable) by recipient who can thus submit a claim for the payment offered

5. A recipient account, including a recipient ID, is registered

6. A recipient's claim submission is registered

7. An EV payment bet is executed to determine whether the claim submitted is worth a payoff multiple of its original value

8. If the claim is a winner, the submitter is informed that the claim is provisionally worth the payoff of the EV payment bet

9. If the submitter claims the payoff from the bet, a payoff claim is registered and a system-authorized inspector verifies whether the payment offer conditions were met

a. Upon a negative determination entered by the inspector, the system registers that, the payoff claim is disqualified

b. Upon a positive determination entered by the inspector, the system registers that the claim is worth the EV payment bet payoff.

Methods and systems employing variations of the method above were disclosed in patent applications filed by the author, including patent application Ser. Nos. 09/536,727 and 10/042,975 describing a method and system for paying qualified audiences for attention to sales messages; patent application Ser. No. 10/424,190 describing a method and system for paying commissions to referrers and; provisional application No. 60/529,071 describing a method and system for paying targeted discounts to qualified buyers.

All these applications are incorporated by reference.

This Book III describes several methods for transferring payments from payers to recipients within an EVMPV and an EVSPV. This Book III does not concern itself with all the steps of an EVMPV, but with the payment transfer steps.

Note: In all cases below, if the EVSPV collects payment from payers, the EVSPV will include well-known debit and/or credit account processes. Further, the EVSPV will include well-known mechanisms for accepting payment and for notifying a payer and/or for suspending a payer's offer when her account has a low balance or an overdue balance.

Inspection (Verification) Process Reviewed

The EVMPV and EVSPV include steps for triggering a verification process, which we usually call an inspection process, and for registering the results of the inspection.

Let us briefly review an inspection process in the EVSPV so we can refer back to it.

When a user has submitted a payoff claim, the EVSPV (the system) will assign the claim data a status indicating that the claim data is to be examined by a system-authorized inspector. Thus, to enable an inspector to decide whether the user has met the offer conditions, the invention will provide a module for:

informing a system-authorized inspector that a claim is to be inspected,

enabling the inspector to inspect the claim data and,

enabling the inspector to view the corresponding payment offer.

The inspection will take place outside of the inventive system, and the inspector will enter the decision of the inspection into the system.

The system can enable an inspector to enter an inspection report explaining why he has rejected a claim, i.e., the system can include a standard menu of explanation options (like form-letter responses) that an inspector can select from to explain his claim rejection, or can enable him to enter a custom written explanation of his own.

If the inspector approves a claim, the system passes the inspector's decision to a payment transfer process for transferring the payoff to the user.

Example Scenario

In this specification, we will use a single scenario to make the methods disclosed clear.

For this scenario, we assume that an EVSPV is implemented within an online database that is a “service bureau” for more than one payer.

Second, we assume a payer, called BestSitter, that provides babysitting services, and that uses the EVSPV to make and transact payment offers.

Third, we assume that BestSitter has established a user account, including bank account.

Fourth, we assume the BestSitter posts three different kinds of payment offers: an offer to pay qualified prospects to view BestSitter's website, an offer to give a discount to qualified lower-income families, and an offer to pay people who refer in customers.

We note that the invention is not limited to this scenario or to the types of payment offers described in this scenario.

Definitions for Book III

EVMPV. See above.

EVSPV. See above.

Payer. A person or organization (or an agent) offering an EV payment using the EVSPV. For convenience, also referred to as Paula.

Payer Bank Account. An account, maintained in the system, in which a payer deposits money (or a virtual account for keeping track of what the payer owes).

Payment Offer. An offer to pay a person or organization that meets/fits specified conditions a specified amount of money or a specified percentage of a sale (a sale is meant broadly to encompass any money or commodity transaction).

Recipient. A person or organization (or an agent) submitting a claim for payment. Also called a claimant. For convenience, also referred to as Reece.

System Bank Account. An account, maintained in the system for the system's money, to receive payment from payers and give payment to recipients (and possibly to send money to another system account for keeping system revenues).

Claim. A claim submitted for an EV payment corresponding to an EV payment offer.

Payoff claim. A claim submitted for a payoff from a winning EV payment claim.

Inspector. A system-authorized user who (1) decides whether a payoff claim is valid and (2) provides the inspection decision to the EVSPV.

### Part 1

### Payer Takes All the Payoff Risk

How the EVSPV enables payoffs to be transferred from payers to recipients depends on who takes the payoff risk. In this Part 1, we assume that the payer takes all the payoff risk.

If the payer assumes the all payoff risk that means that the payer has to pay the full payoff if a claim “wins” the payment bet that the EVSPV executes.

In this case, the system does not necessarily have to collect payment; it can be an accounting machine in the sense that it registers payment obligations but does not transfer actual payment. Thus, the system can include steps for notifying payers of their payment obligations and for notifying winning, qualified claimants that they are owed a payoff amount from a given payer.

For example, assume BestSitter is offering $10 EV to referrers, and assume that Ray, a referrer, wins $1,000 in the payment bet based on this offer, and assume that Ray meets the conditions of the offer. Then, EVSPV will notify Ray that BestSitter owes him $1,000 and will notify BestSitter that it owes Ray $1,000.

Alternatively, EVSPV can include a process for transferring payoffs from payers to winning, qualified claimants. This process includes steps for:

establishing a bank account for a payer,

receiving funds into in this account and,

transferring a payoff from the payer's account to a qualified claimant who has a winning, inspected, valid claim.

Using a Two-Bet (“Parlay”) Process

Instead of using a single bet, an EVMPV and EVSPV can use a two-(or more)-bet process.

Accordingly, the invention provides a method for operating an EVSPV including the steps of:

execute a first bet in which Reece's payment claim has a given, first EV=x, and a First Payoff=y,

if Reece's claim loses this first bet, then set the claim value to zero, and do not continue executing bets for the claim,

if Reece's claim wins this first bet, then execute a second bet in which Reece's claim has an EV=y, and a Second Payoff=z,

if Reece's claim loses this second bet, then set the claim value to zero, store the result, and do not continue executing bets for the claim,

if Reece's claim wins this second bet, credit Reece's claim with provisional value=z.

One advantage of a parlay bet is that an initial bet payoff may not be enough to justify doing an inspection, but may justify inducing a claimant to supply payoff claim information, which can be used to set the terms of a second bet that has a higher EV and payoff than in the first bet (see Part 5 for an example case).

Another advantage of a two-bet process is that an EV payment claimant can be informed if he has won the first stage bet, and can be queried as to whether he meets the terms of the payment offers. The claimant's response can then be registered in a claims database and a user database.

For example, assume BestSitters offers Reece $1EV if he calls BestSitters, and if he buys babysitting services within 2 weeks of making the call. And assume that Reece calls BestSitters, using an EVSPV that registers Reece's claim to the $1EV.

Further, assume that this EVSPV executes a first bet in which Reece's claim has a payoff of $100 and a probability winning of 0.01. Further, assume Reece's claim wins this first bet.

Then, the EVSPV can query Reece and ask him if he indeed did buy babysitting services within two weeks of making his call to BestSitters. Reece can ignore the query, and the EVSPV can register this lack of response or, Reece can respond, “yes,” or “no,” and the EVSPV can register these responses as well.

If Reece responds, “yes,” then the EVSPV can execute a second bet. In this second bet, Reece's claim will have an EV=$100. Assume that the payoff is $500 and the probability of winning is 0.2. Finally, assume that Reece's claim wins this second bet, then the claim is provisionally worth $500, until an inspection takes place to see if Reece has met the conditions of the offer, that is, to see if Reece actually did buy babysitting services within two weeks of the call.

By querying recipients whose claims have won a first-stage bet, the EVSPS can gather and store data in a claims database and a user database (these databases can be a single database) so that a recipient's claiming history can be analyzed, particularly to find a pattern of cheating.

Accordingly, the invention provides a method for operating an EVSPV including the steps of:

query a claimant upon a claim winning a first payment bet,

ask the claimant whether the claimant has met the conditions of the EV payment offer,

store claimant's response or lack of response, in a claims database and/or a user database.

### Part 2

### System Takes All the Payoff Risk in Which EV is Deducted Per Bet from Payer

In this Part 2, we assume that the EVSPV takes all the payoff risk in payment bets.

If the EVSPV takes the payoff risk, it will include a system bank account and means discussed above for establishing a payer bank account.

We assume that a payer, Paula, has established a payer bank account.

Then, each time a recipient submits a claim corresponding to Paula's payment offer, the EVSPV will deduct the amount of money specified by Paula's offer from Paula's bank account (for instance, a debit account) and transfer it into an EVSPV account. From that EVSPV account the system will pay payoffs to recipients.

But the process is more complicated than that; it is different from a conventional payment transfer system. The problem is that Paula is offering EV payment only to qualified claimants, but claimants who accept her offer will include qualified claimants and non-qualified claimants.

Assume that Paula offers $1 EV. Now, assume that 2,000 claimants accept her offer.

How much does Paula owe the EVSPV? If she pays $1 per claim it is not fair because she is only supposed to pay for qualified claimants. She does not know and the EVSPV does not know what percentage of claimants is qualified.

Paula and the EVSPV cannot know if a claimant is qualified until the uncertainty is resolved when, and if, a claimant wins his payment bet and submits his payoff claim data for inspection.

Therefore, to compensate Paula for having money deducted from her account for invalid claims (submitted by non-qualified claimants), the EVMSP and EVSPV can include the step of refunding a payoff, provisionally won by a claimant, to Paula when:

1) a claimant does not submit a payoff claim on a winning claim (usually meaning that the claimant does not think that he is a qualified claimant)

2) a claimant does submit a payoff claim, but the corresponding inspection then reveals that the claimant is not qualified—i.e., that payoff claim is invalid.

For example, assume BestSitter is offering $1 EV to referrers. And, assume that Ray, the referrer, finds the offer, and selects the offer, thereby claiming the $1 EV. Then, the EVSPV would deduct $1 (definite dollar) from BestSitter's bank account and transfer it into an EVSPV account for paying off winning, valid claims. Assume that Ray's claim wins the payment bet with a payoff of $1,000. Then, assume that Ray does not submit a claim for the payoff. Then, the EVSPV would transfer to $1,000 to the BestSitter account. Likewise, if Ray does submit a claim for the payoff, but the claim is found invalid, then the EVSPV would transfer to $1,000 to the BestSitter account.

Accordingly, the invention provides a method for operating an EVSPV including the steps of:

register a claim by a Reece for a payment corresponding to Paula's EV payment offer,

deduct from Paula's account an amount of definite dollars equal to the EV of Paula's offer, and transfer that definite amount to an EVSPV account,

execute a payment bet to determine whether Reece's claim is a winner,

if claim loses, set the value of the claim to zero,

if the claim wins, ask Reece to submit a payoff claim,

if Reece does not respond to the request, or if Reece responds that he cannot submit a payoff claim, transfer the payoff into Paula's account,

if Reece submits a payoff claim, pass the claim to an inspector,

if the inspector enters that the claim is invalid, then transfer the payoff into Paula's account,

if the inspector enters that the claim is valid, then transfer (or authorize the transfer of) the payoff to Reece.

(To compensate an inspector and encourage users to only submit valid payoff claims, the system can include a process for receiving an inspection fee from a payoff claimant, and/or an inspection deposit, to be forfeited if the claim is invalid.)

The Problem with This Refund Method

The method of refunding payoffs to payers is fair in that, probabilistically speaking, on average, Paula gets back the money, deducted from her account, that pays for non-qualified claimants.

However, this “refunding” process is “lumpy” “lumpy” with infrequent, large payoff refunds that may not suit many payers, especially if the payoffs are too infrequent. For example, if Paula is offering $1 EV, and the payoff is $1,000, Paula may have over $1,000 deducted from her bank account to pay for non-qualified claimants, but she may not even receive a payoff refund. This situation will be unsatisfactory to many payers, especially payers that are very small businesses.

Below we give is one solution to this problem. In Parts 3 and 4 we describe two other solutions.

Using a Two-Bet (“Parlay”) Process

One solution is to split one payment bet into two, in which the payoff for the first bet is low enough so that a payer will receive refinds of a first payoff frequently enough to satisfy the payer (Paula). An EVMPV and EVSPV can use a two-bet process, as described in Part 1, with two key differences.

One difference is that the system takes the payoff risk in both payment bets. The EV amount is deducted, in definite money, from Paula's account, per claim submission (offer acceptance).

A second difference is that the first bet payoff is refinded to the payer if the claimant (Reece) does not respond to a query after winning the first-stage bet, or if Reece gives a negative response, saying, “I did not meet the conditions of the payment offer.”

If Reece gives a positive response, a second bet is executed. If Reece's claim wins this second stage bet, then the claim is provisionally worth the second payoff.

Paying this payoff is handled the same way that a payoff claim is handled above, in Part 2. That is, if an inspection reveals that Reece's claim is invalid, then the second stage payoff is refunded to the payer. If the inspection reveals that Reece's claim is valid, then the second stage payoff is paid to Reece.

Accordingly, the invention provides a method for operating an EVSPV including the steps of:

register a claim by Reece corresponding to an EV payment offer by Paula,

transfer from Paula's bank account to an EVSPV account an amount of money (x) equal to the EV offered in by Paula's offer,

execute a first bet in which Reece's payment claim has a first EV=x, and a First Payoff=y,

if Reece's claim loses this first bet, set Reece's claim value=zero, and do not continue making payment bets for the claim,

if Reece's claim wins this first bet, query Reece to see if he says he has met the conditions of the payment offer,

if Reece does not respond, or if Reece responds, “no,” then transfer (“refund”) the First Payoff, y, to Paula's account,

if Reece responds, “yes,” then execute a second bet in which Reece's claim has an EV=y, and a payoff=z,

if Reece's claim loses this second bet, set Reece's claim value=zero, and do not continue making payment bets for the claim,

if Reece's claim wins this second bet, assign Reece's claim provisional value=z

ask Reece to submit payoff claim data,

if Reece does not respond or if he says he cannot submit payoff claim data, then transfer (“refund”) the Second Payoff, z, to Paula's account,

if Reece does submit payoff claim data, then send the data to an inspector to do an inspection,

if the inspector finds the claim invalid, register that the claim is invalid and transfer (“refund”) the Second Payoff, z, to Paula's account,

if the inspector finds the claim valid, pay the Second Payoff, z, to Reece's account (or authorize payment to Reece).

### Part 3

### Two-Bet Process Where Payer and System Take Separate Payoff Risk in Which the First Bet Payoff is Deducted from Payer

Part 1 described a two-bet process in which the payer takes the payoff risk in both bets. Part 2 described a two-bet process in which the system takes the payoff risk in both bets.

This Part 3 describes a two-bet process in which the payer takes the payoff risk in the first bet, and the system takes the payoff risk in the second bet.

This particular two-bet method can be useful because many payers cannot risk losing a large payoff, while virtually all payers can risk losing a payoff under a given threshold.

We note that the EVMPV can include steps for enabling a payer to set this threshold, or the threshold can be set by default. This threshold—a static amount or a multiple of a sale amount—can then be used as the payoff for the first bet in a two-bet process.

(As in Parts 1 and 2, we will often call a payer by the name, Paula, and an EV payment recipient/claimant by the name, Reece.)

Accordingly, the invention provides a method for operating an EVSPV including the steps of:

register a claim by Reece corresponding to an EV payment offer by Paula with EV=x,

execute a first bet in which Reece's claim has an EV=x, and a First Payoff=y,

if Reece's claim loses this first bet, set Reece's claim value=zero, and do not continue making payment bets for the claim,

if Reece's claim wins this first bet, then query Reece to see if he says he has met the conditions of the payment offer,

if Reece does not respond, or if Reece responds, “no,” set claim value=zero,

if Reece responds, “yes,” transfer y from Paula's account to an EVSPV account,

execute a second bet in which Reece's claim has EV=y, and Second Payoff=z,

if Reece's claim loses this second bet, the claim has zero value,

if Reece's claim wins this second bet, the claim has provisional value=z,

ask Reece to submit payoff claim data,

if Reece does not respond or if he says he cannot submit payoff claim data, then transfer (“refund”) the Second Payoff, z, from the EVSPV account to Paula's account,

if Reece does submit payoff claim data, then send the data to an inspector to do an inspection,

if the inspector finds the claim invalid, register that the claim is invalid, and transfer (“refund”) the Second Payoff, z, from the EVSPV account to Paula's account,

if the inspector finds the claim valid, pay Reece the Second Payoff, z, from the EVSPV account.

Importantly, we note that the process above does not have to include steps for informing Reece that his claim has won the first bet; the two-bet aspect can be hidden from him. In this implementation, Reece would not be queried, of course, after the first bet. The First Payoff would be transferred from Paula's account to an EVSPV account, as above. But, in order for Reece to be queried, Reece's claim would have to win both bets. If Reece did not respond to this query, or he if he did respond, and his claim was found invalid, then the EVSPV would transfer the payoff to the Paula's account.

Illustration

As an illustration of the process above, assume that BestSitters sets up an account with the EVSPV and deposits $200.

Assume that BestSitters makes an offer to pay $1 EV to anyone who refers in a customer.

Assume that Ray accepts this offer, that is, submits a claim.

Then the EVSPV registers the claim and executes a first bet with EV=$1 and, let us assume, a First Payoff=$50.

Assume that Ray's claim wins the bet.

Then, the EVSPV deducts $50 from BestSitter's account and transfers it to an EVSPV account for paying payoffs.

Then, the EVSPV informs Ray that his claim has won the first bet and asks Ray whether he has met the conditions of the corresponding payment offer.

If Ray does not respond, or responds negatively, then the EVSPV refunds the $50 to the BestSitter account.

If Ray responds positively, then a second bet is executed, with an EV=$50 and a Second Payoff=$1,000, let us assume.

Then, if Ray wins this bet, the EVSPV asks him to provide proof that he referred in a customer.

If Ray does not respond, or does not provide adequate proof, the EVSPV transfers the $1,000 to the BestSitter account.

If Ray does respond and provides adequate proof of his referral, then the system authorizes the payment of (or simply pays) the $1,000 to Ray.

### Part 4

### System Takes All the Payoff Risk and Uses a Discount Formula to Adjust for Invalid Claims

One way for the EVSPV to transfer payment from payers to recipients is to take all the risk in the payment bets, but to eliminate the refinding steps described in Part 2, and instead use a discount formula that generates a discountfactor of some sort.

In Part 2, we described a method in which each time a recipient submits a claims corresponding to Paula's EV payment offer, the EVSPV will deduct definite money in the EV amount of the offer from Paula's bank account and transfer it into a EVSPV account. From that EVSPV account the system will pay valid, winning claims.

To repeat from Part 2, the process is more complicated than that; it is different from a conventional payment transfer system. The problem is that Paula is offering EV payments only to qualified claimants, but people who accept her offer—submit claims, that is—will include qualified claimants and non-qualified claimants.

To repeat, Paula and the EVSPV cannot know if a claimant is qualified until the uncertainty is resolved by the claimant winning his payment bet and then passing/failing an inspection.

To compensate/adjust for non-qualified claimants, the EVSPV can include a process for applying a discount factor to the EV payment amount that Paula offers to claimants.

Then, each time a user submits a claims for an EV payment under Paula's offer, Paula would not owe EVSPV the full amount of the EV stated in the offer, but a discounted rate. For example, if the EV amount offered to qualified claimants is $1 and the discount factor is 20%, then EVSPV registers that Paula owes 20 definite cents per submitted claim.

The goal in a discount factor is to represent the percentage of claimants who are qualified claimants. To arrive at a fair discount factor, the general idea is to gather statistics on what percentage of claimants are qualified.

These statistics can be gathered from the responses to offers within EVSPV that are similar to Paula's offer. The EVSPV can feed this response data into the discount formula(s).

Other methods, such as survey methods can be used as well to yield discount factor data to be fed into discount formulas as well.

The discount formula(s) will use data on how many winning claims are qualified claims.

EVSPV may include one or more formulas to determine the discount factor to be applied to a payer's offer.

Accordingly, the invention provides a method of operating an EVSPV such that the EVSPV takes the payoff risk in EV payment bets and further includes:

a discount formula process (or processes) for arriving at a discount factor, to be applied to the EV amount of a payment offer.

(Alternatively, in certain implementations, the EVSPV will not include a discount formula, but will include means for enabling a system administrator to enter a discount factor.)

Further, when a user submits a claim for EV payment, the EVSPV will:

apply the appropriate discount factor to the EV payment amount,

deduct the resulting amount from the payer's bank account,

transfer the amount to a EVSPV account that is used to pay winning, qualified claimants.

Further, in the inspection process, when an the inspector approves a claim, the EVSPV will:

register that the claimant is owed the payoff from the EVSPV account that is used to pay winning claimants.

Note that while the amount being deducted from Paula's account is (EV)×(Discount Factor), or EV adjusted in some way by a discount formula, the EV of the payment claim remains the EV that was offered by Paula.

Thus, one weakness of the process above is that Paula and Reece can cheat by acting in cahoots. Because of the discount factor, the amount that Paula has to pay is not the full EV, while the system executes a bet where Reece does receive the full EV. The system makes up the difference. So, if Paula and Reece are cheating, they will receive, on average, (EV)−(EV×Discount Factor).

Using a Two-Bet Process Where Payer and System Take Separate Payoff Risk in Which the First Bet Payoff, Adjusted by a Discount Factor, is Deducted from the Payer's Account

The EVSPV can enable Paula to take the payoff risk in the first bet, but can apply a discount factor to this First Payoff. Thus, if the claimant wins this first bet, the system can deduct the First Payoff of this first bet, adjusted by the discount factor described above, from Paula's bank account and transfer this discounted First Payoff to the EVSPV account.

The EVSPV can then take the payoff risk in the second bet.

As with the process above, although a discount factor is applied to Paula's payoff obligation, the EV of the claim in this second bet equals the full First Payoff (the payoff of the first bet).

If the claim wins both bets, and if an inspection finds the claim valid, then the EVSPV transfers the second bet payoff to Reece.

### Part 5

### Two-Bet Processes in Which EV Payment Equals a Percentage of a Sale

Context: Payment Offers Where the EV Payment Depends on an Uncertain Event, Especially a Purchase Amount (an Amount of Money in a Transaction)

In many kinds of EV payment offers, the amount of EV payment will depend on an uncertain event or series of events, such as the amount of a sale.

In particular, the amount of EV payment can be a percentage of the amount of money involved in an economic transaction, which we will call a sale amount, where sale is a generic term that encompasses any kind of sale, lease, loan, donation—and amount encompasses any amount of money transferred in an economic transaction.

For instance, BestSitters might offer Reece a payment for attention where the EV payment is 1% of how much Reece spends on babysitting services over the next month. In this case, the sale amount, and hence the specific EV payment amount, will not be known until the month has passed.

The EVMPV and EVSPV can include steps for handling payments that are contingent upon uncertain events, in particular, payments that are a percentage of sale amounts.

The steps involved are straightforward if one payment bet is used. In this case, the claimant will provide the sale amount information during the inspection process.

For instance, if BestSitters offers 1% of a sale amount to Reece, then a bet is executed. Let us assume that the probability of Reece's claim winning is 1/1000. Then, if Reece's claims wins, it will be worth 1%×1,000=10,000%=10 times the sale amount.

If Reece's claim wins, the EVSPV will ask Reece if he bought babysitting services over the past month, and if so, how much did he spend?

Let us assume Reece spent $80, then he will be owed $800.

So, to handle percentages, a payoff multiple is used in the EV payment bet.

Two-Bet Processes Where Uncertainty is Resolved (Sale Amount Information is Provided) After the First Bet

If a two-bet process is used, then the first bet can use a payoff multiple.

Let us assume that the process of Part 3 is used in which Paula takes the payoff risk in the first bet and the EVSPV takes the payoff risk in the second bet.

The invention provides a method for operating an EVSPV including the steps described below.

If Reece's claim wins the first bet, the EVSPV can ask Reece if a sale was made, and if so, how much was spent. Reece can supply the answer, and the second bet terms can be based upon this information.

For example, let us assume the payoff multiple in the first bet is 10×, so that the probability of a claim winning is 1/10. Then, if Reece's claim wins this first bet, the claim is provisionally worth 10× the EV payment percentage offered.

Then, the EVSPV asks Reece if a sale was made, and if so, how much was spent. If Reece responds and supplies the sale amount, then this sale amount can be multiplied by the payoff multiple and multiplied by the EV payment percentage to arrive at a First Payoff that can be deducted from Paula's account.

For instance, assume the EV payment percentage offered is 1%. Assume the payoff multiple is 10×. And, assume that Reece says that a $600 sale was made. Then, (1%)×10×$600=$60. This $60 is transferred from Paula's account to the EVSPV account for paying payoffs. And, this $60 is the EV of the second bet.

Two-Bet Process Where the Uncertainty is Resolved (Sale Amount Information is Provided) After the Second Bet

It is also possible NOT to tell Reece that his claim has won the first bet, but simply to deduct some amount of definite money from Paula's account to be transferred into an EVSPV account, that is then used by pay out payoffs.

But, if the sale amount is not known, how much definite money is to be deducted from Paula's account?

One solution is for the EVSPV to check Paula's payment offer and assume the worst-case scenario, that Reece will report that largest sale possible under Paula's offer. The EVSPV, in other words, can deduct the maximum amount from Paula's account.

This method raises the problem of overpayment. To solve this problem, the refunding approach of the processes of Part 2 and Part 3 can be used.

When the uncertainty of the sale amount is resolved, the excess payment in definite dollars can be refunded, but refunded multiplied by the payoff multiple.

For example, assume that the payoff multiple of the first bet is 10×, and assume that the payment offer is 1% of a sale amount. Then, Reece is owed 10% of the sale amount.

Assume that the maximum sale amount under Paula's offer is $1,500, then Reece could potentially be owed $150. The EVSPV can deduct this amount from Paula's account.

Then, let us assume that the payoff multiple of the second bet is 10×as well. Then, if Reece's claim wins this bet, the claim is provisionally worth $1,500.

Now, let us assume that Reece submits a payoff claim stating that he spent $90.

Then, Reece would be owed $90 as the second payoff, NOT $1,500.

But, if the uncertainty had been resolved after the first bet, then Paula should only have paid $9, which is 10%×$90. Instead, Paula had $150 deducted from her account. So, she is owed $141. But, it is actually $141×10×−$1410.

Because of the complexity of this approach, it seems that, in practice, the uncertainty will be resolved after a claim wins a first bet, as described above.

### Part 6

### Using Deposits to Reduce Inspection Costs

Inspecting a Fraction of the Payoff Claims

We expect that in most implementations of the invention, a claimant would have to put up a deposit or pay an inspection fee, both of which can ensure that his claim was valid.

The inspection fee would be paid whether the claim was valid or not. The deposit would be forfeit if the claim were invalid.

A twist on the idea of a deposit, to increase the efficiency of inspection, is to ask claimants to put up a large deposit (to post a bond, so to speak), and only inspect a fraction of the claims, with some pre-set selection method (e.g., random selection of claims).

The un-inspected claims would be presumed valid. The inspected claims, if invalid, would cause the deposit to be confiscated.

Accordingly, the invention provides a method of operating an EVSPV including the steps of:

executing an EV payment bet for a claim,

if the claim is loses, set the value=0,

if the claim wins, ask claimant to submit deposit of money to guarantee that the claim is valid,

if the claimant does not submit the deposit, set the value of the claim=zero,

if the claimant submits the deposit, store the deposit in an escrow-type account such that the deposit corresponds to the winning claim,

subject the claim to a pseudo-random chance of being inspected according to a pre-set selection formula,

if a winning claim has not been selected for inspection, assume that the claimant meets the conditions of the EV payment offer, pay the winning claimant the payoff, and release the deposit from the escrow account back to the claimant,

if a winning claim has been selected for inspection, request payoff claim data (inspection data) from the claimant,

if the claimant does not provide the payoff claim data, set the value of the claim=0, and confiscate the claimant's deposit,

if the claimant provides payoff claim data, inform an inspector that the claim needs inspecting,

if the inspector enters a decision that the claim is invalid, set the claim value=0, and confiscate the claimant's deposit,

if the inspector enters a decision that the claim is valid, set the value of the claim=to the payoff of the payment bet, and authorize payment of the payoff to the claimant, and release the deposit from the escrow account back to the claimant.

Centering the Invention Around the Use of Deposit (Around the Posting of Bonds)

The EVMPV and EVSPV use expected payments to reduce the number of inspections of claims.

It is possible to reduce inspections solely by using the method of having claimants post a bond to vouch for the honesty of their claims, and then auditing a percentage of those claimants.

We do not feel that this will be the dominant approach in the market because it requires people to put up large deposits upfront, but we note the possibility.

Instead, by reducing the average cost of inspections, the use of deposits may be an important addition to the payment processes of an EVMPV and EVSPV.

Further, and as a separate, useful process, the EVMPV and EVSPV can include steps that enable a claimant to choose whether to be paid:

1) an EV payment or

2) a definite payment contingent upon the claimant putting up a deposit and having the claim subject to inspection, according to a mostly/somewhat random selection.

This approach can work well when an EVSPV enables EV payments that range from small, say, 10 EV cents, to large, say 300 EV dollars. In some cases, claimants will prefer to receive definite payment rather than EV payment.

### Part 7

### Miscellaneous Sub-Methods for Efficient and User-Friendly Transactions

Periodic EV Payments

In certain cases, an EV payment offer may stipulate that Reece will be paid periodically, such that he must meet the conditions of the payment offer during each, defined period. For example, Paula may offer to pay Reece a 5% EV referral fee for each month that a customer buys from Paula. Each month, then, Paula can check whether the customer has remained a customer. When the customer drops away, then Reece is no longer owed the EV referral fee.

The EVMPV and EVSPV can accommodate periodic payments by treating each period as a separate payment that requires a separate claim to be made. Or the EVMPV and EVSPV can enable a singe claim to trigger a series of payment bets, per period, that continue until a claimant requests that they stop. Or, the EVMPV and EVSPV can assume that the first period payment will determine the total payment. The possibilities are various and will depend upon the implementation and the payment offer.

Allowing Recipients to Assign EV Payments

One problem with the EVMPV and EVSPV is that many claimants do not like EV payment and would prefer definite payment. A way to solve this problem is for a claimant, before the result of his EV bet is revealed, to assign his EV bet payoff to a third party. The third party could pay the claimant a percentage of the EV for this assignment, through a private transaction, thus enabling the claimant to receive definite payment instead of EV payment. The third party would then collect the payoff, if any, upon a successful inspection.

Alternatively, the EVSPV can facilitate and record assignments. Further, the EVSPV could list EV payments to a recipient so that a recipient can assign a set of EV payments to a third party.

Accordingly, the invention can provide a method for operating an EVSPV including the steps of:

enabling a user to designate an assignee for one or more of the EV payments he claims,

enabling a user to state which EV's he is genuinely eligible for—i.e., claims in which he has met the conditions of the EV payment offers,

listing and tallying all the claims for EV payment a user has stated he is genuinely eligible to receive,

designating an assignee for the set of claims for EV payment a user has stated he is genuinely eligible to receive.

Showing Net EV's

The owners of an EVSPV will usually need to be paid for its operation. As discussed, there are various ways of charging users for the services of the EVSPV. Some of these ways will involve transaction fees. These fees can be reflected in the EV's, odds, and payoffs of payment bets. That is, the EVSPV can show net EV's to claimants/recipients that are different from the EV's advertised by payers in their payment offers.

Meta-Directory for Collecting and Sorting Similar EV Payment Offers

An EVSPV that transacts a particular kind of payment offer, such as a system for targeted discount offers, or referral offers, or payment-for-attention offers, will probably not be a monopoly service. There will be more than one EVSPV doing essentially the same thing.

Given this reality, it will be useful for payers and recipients of payment to collect all similar offers and put them in one sorted list. In other words, it will be useful to create a meta-directory of offers that are posted in EVSPV's.

This kind of meta-directory can be created through a central service that handles queries from payment claimants and then pulls matching offers from various EVSPV's and sorts those offers.

Or, the meta-directory can be created via software on a user's personal machine, such that the software takes a user query for a payment offer and then pulls matching offers from various EVSPV's, and sorts those offers, and presents a sorted list of those offers.

A meta-directory is obviously helpful to payment claimants. But it is also helpful to payers, especially a central service embodiment, because it can help collect global statistics that can be used to deter cheating and make payment offers more efficient.

I claim:

1. A method for paying commissions, using an online computer database system, comprising the following steps:
establishing a seller account for a seller,
registering a referral fee offer by said seller,
establishing an account for a user who will submit a referral claim,
enabling said user to find said referral fee offer,
registering in a claims database a referral claim corresponding to said referral fee offer,
executing a payment bet for the claim in which the expected value equals the referral fee in said referral fee offer,
if said claim loses said bet, registering the loss in said claims database,
if said claim wins said bet, registering the win in said claims database and:
informing said submitter that said the claim is a winner and is provisionally worth said payoff,
enabling said submitter to submit a payoff redemption request corresponding to said winning claim,
if said submitter submits said redemption request, registering said request, and informing a system-authorized inspector about the request,
enabling said inspector to enter a decision as to whether said winning claim is valid according to the term of the referral fee offer,
registering said inspector's decision as to whether said winning claim is valid,
upon a negative decision, informing said submitter that said winning claim is invalid,
upon a positive decision, notifying said seller that it owes the payoff for the winning claim.
